(19) United States
(12) Patent Application Publication
(10) Pub. No.: US 2008/0288390 A1
(43) Pub. Date: Nov. 20, 2008

(54) COMPLEX ORDER LEG SYNCHRONIZATION

(75) Inventor: Greg Maynard, Port Washington, NY (US)

Correspondence Address: FROMMER LAWRENCE & HAUG, 745 FIFTH AVENUE- 10TH FL., NEW YORK, NY, 10151, US

(73) Assignee: International Securities Exchange, LLC

(21) Appl. No.: 12/110,863

(22) Filed: Apr. 28, 2008

Related U.S. Application Data
(63) Continuation-in-part of application No. 10/771,993, filed on Feb. 3, 2004.
Application No. 10/771,993 is a continuation-in-part of application No. 10/418,908, filed on Apr. 18, 2003, now Pat. No. 7,246,093.
Application No. 10/418,908 is a continuation of application No. 09/433,613, filed on Nov. 2, 1999, now Pat. No. 6,618,707.
(60) Provisional application No. 60/106,935, filed on Nov. 3, 1998.

(51) Int. Cl. G06Q 40/00

(52) U.S. Cl. 705/37

(57) ABSTRACT

A system is provided for trading complex orders for financial instruments, including complex orders that include legs that are to be executed on different markets. The legs of the order are optionally specified to be executed in a particular ratio, at net price, and/or at a range of net prices. The system halts trading for all legs in one market, determines a quantity and price to execute a second leg of the order on the other market to achieve a specified ratio or net price and then submits the second leg for execution on the other market if the second leg remains marketable on the other market. If an execution is received from the other market, then the legs in the first market are executed and the series unfrozen. If the other market has not responded after a predetermined time, then the legs in the first market are unfrozen and trading continues.

### RELATED APPLICATIONS

The present application is a continuation-in-part of U.S. patent application Ser. No. 10/771,993, filed Feb. 3, 2004, which is a continuation-in-part of U.S. patent application Ser. No. 10/418,908, filed Apr. 18, 2003, issued as U.S. Pat. No. 7,246,093, which is a continuation of U.S. patent application Ser. No. 09/433,613, filed Nov. 2, 1999, issued as U.S. Pat. No. 6,618,707, which claims priority under 35 U.S.C. § 119(e) to U.S. Patent Application No. 60/106,935, filed Nov. 3, 1998. U.S. Pat. No. 6,618,707 is incorporated herein by reference.

### FIELD OF THE INVENTION

This invention relates generally to markets for trading financial instruments. In particular, the present invention relates to an automated exchange for matching and executing complex orders consisting of multiple legs that are executed on different markets where trading in at least one leg is frozen while another leg is executed in another market.

### BACKGROUND OF THE INVENTION

Embodiments of the present invention are directed to the execution of complex orders for equity options contracts and underlying equities. As discussed more fully below, the present invention is not limited to complex orders for equity options, but is applicable to trading complex orders for other types of financial instruments, for example, index options contracts, futures contracts, stocks, bonds, exchange traded funds, security futures, commodities, treasury instruments, currencies, and the like as well as combinations of such instruments. Known markets for trading these other instruments suffer from the same shortcomings as do equity option markets, and the advantages of the invention are applicable to these instruments as well.

Investors often wish to purchase or sell different option contacts related to the same underlying security at the same time, as part of an overall investment strategy to take advantage of anticipated movements in the price of underlying equities or to hedge their investments against such fluctuations. For example, some well known strategies are “butterflies,” “spreads,” “straddles,” “strangles,” and the like. Each of these strategies requires that the investor purchase and sell a number of different financial instrument related to the same underlying security. Orders for such transactions are called complex, combination, combo, or spread orders. For simplicity, these will be referred to herein as complex orders. Each purchase or sale of a security making up the complex order is referred to as a “leg” of the complex order.

For example, a “straddle” is an order to buy (or sell) a number of call option contracts and the same number of put option contracts on the same underlying security with the same exercise price and expiration date. A complex order to execute a straddle consists of two legs; the first leg is an order to buy, for example, two XYZ July 50 calls and the second leg to buy two XYZ July 50 puts. Such an order allows the investor to benefit if the price of the underlying equity XYZ goes significantly above or below the strike price of 50. An investor might place such an order if he anticipated high volatility in the stock price but wants to benefit whether the stock price actually rises or falls.

An investor could execute a straddle by making two separate transactions, that is, submit a buy order for the call options and submit a second buy order for the put options. The investor faces the risk that both transactions will not execute (or will not execute at the preferred price and time) and he will be left with only the put or only the call options. This is called “leg” or “market” risk.

Executing a complex order on known exchanges requires the services of a market professional called a specialist. The specialist receives the complex order and, if he feels it is profitable, executes each leg of the transaction himself or finds existing orders on the market against which he can execute the legs of the complex order. The specialist must devote considerable time and effort to evaluate the profitability of a complex order and/or assemble the necessary counter orders on the market. The specialist is able to command a high commission to execute such orders. In addition, the effort required to execute complex orders often results in these orders being “traded through” or passed over by regular orders that are later in time. Also, because execution of each leg of the order does not take place simultaneously, there is still leg risk. Specialists rarely assume this risk themselves, leaving this for the investor to face. As a result, complex orders traded on known exchanges were costly to investors, had reduced liquidity, and placed investors at market or leg risk.

As discussed above, complex orders can include both an option contract and the equity underlying that option. Two significant trading strategies in these markets include delta neutral trading and buy write trading. These are complex trading strategies, the primary purpose of which is to generate limited premium with limited risk. For example, an investor might wish to purchase call options in a stock and at the same time sell short a certain number of shares of the same stock such that upward movement in the stock price (which diminishes the value of the short sale position) results in a corresponding increase in the value of the call options. In order to achieve the minimum of risk, such an investor may wish to exactly balance the price movement in its option and stock positions to achieve a “delta neutral” position by purchasing (or selling) a certain ratio of options contracts to stock shares.

Such trading strategies today have certain limitations, however, due to the fragmentary nature of markets. Since there is no single market for trading all types of financial instruments that can comprise a complex order, users of these strategies have added “leg risk.” This is because one leg must be executed at one market, and another leg at another market, usually involving different individuals and systems. As a result, two specialists or brokers must cooperate to execute this type of complex order, also resulting in less liquidity and higher commissions. In addition, because prices on both markets may fluctuate continuously, the final price for the complex order cannot be known until all legs are executed. Different markets may also offer different amounts of liquidity. This presents a difficulty in executing a complex order that requires a certain ratio of one instrument to another if the number of instruments on one market is insufficient to fully satisfy one leg of a complex order. If the amount of one instrument is limited, the amount of the other instrument purchased must be adjusted to achieve the desired ratio. This is also true for complex orders for other types of instruments (i.e., futures contracts and the underlying commodity, bond futures and bonds, and the like).

The options market first developed in the 1970s. Since that time, options for the purchase and sale of listed stocks have traded domestically only on floor-based exchanges, for example, the American Stock Exchange (AMEX). The method of trading options contracts in these floor-based environments is known as an “open outcry” system because trading takes place through oral communications between market professionals at a central location in open view of other market professionals. In this system, an order is typically relayed out to a trader standing in a “pit.” The trader shouts out that he has received an order and waits until another trader or traders shout back a two-sided market (the prices at which they are willing to buy and sell a particular option contract), then a trade results. In an effort to preserve this antiquated system of floor-based trading, the transition to and use of computer-based technology on these exchanges have been slow. Although some processes that take place on these floor-based exchanges have been automated or partially automated, they are not fully integrated and, in fact, many processes continue to function manually. As a result, there are many problems with the existing floor-based system that have caused large inefficiencies and inadequacies in order handling and price competition in the options market, and have harbored potential for abuse and mistakes.

These problems are particularly acute for complex orders. For example, most markets have rules which require that trades be allocated first to public customers and then to market professionals. In the rare instances when a specialist seeks to trade the legs of a complex order against other orders, he would need to assure that trades be allocated to give a preference to public customer orders. Market rules also require that trades be executed at the best available price, commonly referred to at the best bid or offer (BBO). On an actively traded securities, the BBO can change several times a second, making it extremely difficult for a specialist to effect such trades. BBO volatility also increases leg risk because the time between leg execution is likely to cause subsequent legs to execute at inferior prices, rendering the entire complex order and trading strategy unprofitable.

Beyond the trading processes internal to each option exchange, additional considerations arise when an option is listed on multiple exchanges. In order to assure that an order in a multiply-listed contract receives the best execution price, market professionals are charged with the responsibility of checking the other exchanges' prices, and may be required to contact the other exchange to verify that the prices are valid. Again, a specialist executing a complex order is faced with a difficult task. The process of checking other exchange prices is dependent upon the originating exchange market professionals' personal efforts to verify the other markets' prices. Where a complex order includes a stock leg, this problem is even more acute since the stock transaction as well as the option transaction must be executed at the best execution price.

The increasing volume of trades in options contracts, as well as the speed at which price information of underlying stocks is transmitted to consumers, has increased the demand for faster trade execution in today's market. In addition, volatility in the price of underlying stocks that are the basis for options contracts place further pressure on exchanges to execute trades quickly and at an equitable price. Market makers on floor-based markets are limited in the speed at which they can react to market fluctuations and respond with quotations. Moreover, the particular difficulties posed by complex orders drive up costs, decrease liquidity, and increase leg risk.

### SUMMARY OF THE INVENTION

It is an advantage of the invention to provide an automated system for trading complex orders that reduces leg risk.

It is a further advantage of the invention to provide an automated system for trading complex orders that assures the complete order will be executed for a net price.

It is yet another advantage of the invention to provide a system for trading complex orders where, prior to executing a complex order, liquidity of each leg of the complex order is assured.

It is a further advantage of the invention to provide a system for trading complex orders where, in the event a leg of the complex order is not executed, orders for the remaining legs are cancelled.

It is a further advantage of the invention to provide a means to synchronize executions of legs of complex orders to be executed on different markets.

Broadly, an exchange for trading complex orders according to the invention stores complex orders along with regular orders from public customers and market professionals, as well as quotations from market makers in a book memory. The exchange automatically compares each complex order against other stored complex orders to determine if the two complex orders can trade. The exchange also compares each leg of the complex order against the regular orders and quotations stored on the book and determines if each leg of the complex order can execute against the regular orders and quotations, either in whole or in part according to the ratios set forth in the complex order. These determinations are made at the current best bid or offer price (BBO), giving preference to customer orders over professional orders. The complex orders are executed against either other complex orders or against regular orders or quotations based on these determinations.

In addition, where a complex order includes a leg in one market and a leg in another market, the system will halt trading in the local legs, effectively fixing the execution price of orders in these legs, while it attempts to execute the remaining leg in the other market. If the order in the other market is executed successfully, the remaining legs are executed.

### BRIEF DESCRIPTION OF THE DRAWINGS

Further characteristics, features, and advantages of the present invention will be apparent upon consideration of the following detailed description of the invention, taken in conjunction with the following drawings, and in which:

FIG. 1 is a block diagram illustrating an automatic exchange according to an embodiment of the invention interconnected with a plurality of market makers, exchange members, and other entities;

FIG. 2 is a detailed block diagram illustrating the exchange of FIG. 1;

FIGS. 3 through 13 are flow charts showing processing by the exchange of FIG. 1;

FIG. 14 is a flow chart showing processing of a complex order according to an embodiment of the invention; and

FIG. 15 is a flow chart showing processing of a complex order according to another embodiment of the invention.

### DETAILED DESCRIPTION

Embodiments of the invention will be described in terms of an automated exchange market for stock options; options being contracts for the purchase or sale of a listed security at a particular strike price to be exercised on a particular date in the future. The invention, however, is not limited to the sale of options contracts and may also be applied to other financial instruments such as stocks, bonds, commodity futures contracts, currency, and the like.

Where appropriate the embodiments will be described in terms of a market for a single option; for example, a put for IBM Class A stock expiring on Jan. 15, 1999 with a strike price of 140. It is to be understood that the exchange according to the invention simultaneously provides a market for a series of options for a number of underlying stocks across a range of exercise dates and at a range of strike prices. The vast number of options that can be traded makes the invention particularly advantageous over less automated systems because many of the routine decisions made by professionals in charge of a series of options can be defined in advance and applied automatically.

Likewise, where embodiments directed to the trading of complex orders are disclosed, the invention will be described in terms of complex orders with legs consisting of options related to a single underlying security, as well as the underlying security itself.

An automated exchange according to the invention is administered by a business entity, for example, the International Securities Exchange, Inc. (ISE) of New York, N.Y., which authorizes certain persons as members. The business entity may authorize different types of members or participants, such as a primary market maker (PMM) and one or more competitive market makers (CMMs) to enter quotations in particular classes of options. While there is only one PMM for each class of options traded on the exchange, there may be multiple PMM participants on the exchange, each trading different classes of options. The business entity may also authorize PMMs and CMMs to place orders in options classes traded on the exchange, as well as one or more broker-dealers to enter orders as principal or agent in options classes traded on the exchange, which broker-dealers shall be referred to herein as electronic access members (“EAMs”).

Orders entered on behalf of registered broker-dealers, including PMMs, CMMs and EAMs, are referred to herein as professional orders. Orders entered on behalf of market makers on competing exchanges 18 are a particular type of professional order referred to herein as “FARMM” orders. Orders on behalf of any party that is not a registered broker-dealer are referred to as public customer orders.

It is to be understood that the names, types and arrangement of participants and orders are used as examples for purposes of illustration. It is to be understood that the particular arrangement of participants and orders may be varied and remain within the scope of the invention. According to one embodiment of the invention, three distinct types of order are defined, namely public customer orders, professional orders and FARMM orders as defined above. Nevertheless, a greater or fewer number of order types may be defined. The embodiments described herein conform to the rules imposed by a certain type of business entity. It is to be understood that an exchange which conforms to a different set of rules is nevertheless within the scope of the invention. Further, it is to be understood that the term “exchange” does not limit the use of the invention to an entity that is a registered exchange; that is, the invention may be administered by other types of business entities, such as broker-dealers, associations or others.

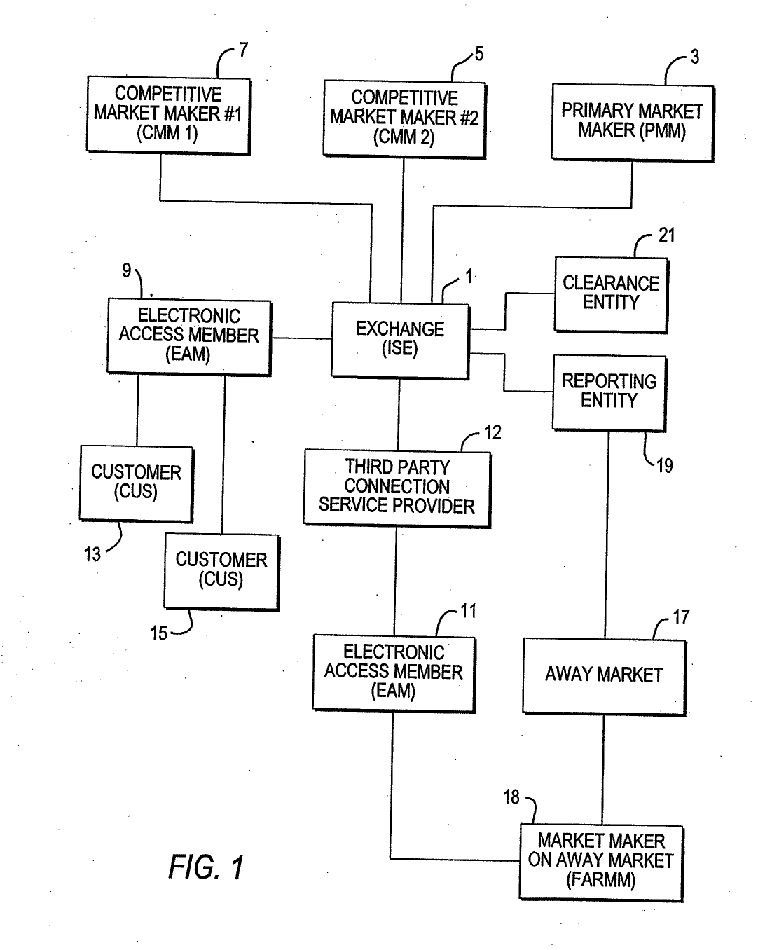

FIG. 1 shows an exchange 1 according to an embodiment of the present invention connected with a number of entities. An order placed on the exchange 1 may be a limit order that specifies an order size, that is, an integral number of contracts, and a bid price or offer price. Alternatively, an order may not specify a bid price or an offer price, in which case the order is referred to as a market order. It is understood that a market order is to be executed at the best available price, which is the highest price in the case of a market order to sell and the lowest price in the case of a market order to buy.

Professional orders and quotations in an options class are communicated to the exchange 1 by the PMM 3 and one or more CMMs 5,7. One or more EAMs 9,11 communicate public customer, professional and FARMM orders to the exchange 1. According to one embodiment of the invention, PMMs and CMMs may only enter proprietary quotations and orders; that is, they may not enter orders as an agent on behalf of a public customer or another professional. According to another embodiment of the invention the PMM 3, CMMs 5,7 and EAMs 9,11 may enter complex orders.

The exchange 1 is also connected with a reporting entity 19. The reporting entity 19 may be, for example, the Options Price Reporting Authority (OPRA), which collects price and size data for all options traded on exchanges in the United States and provides this data to subscribers. The exchange 1 communicates the prices of each trade to the reporting entity 19. The exchange also communicates the best prices available, that is, the highest bid price and the lowest offer price in the book memory 33 discussed below. The reporting entity 19 may also include the Consolidated Trading System/Consolidated Quoting System (CTS/CQS), which collects price data on underlying stock markets. According to one embodiment of the invention applied to the trading of options, the exchange 1 collects data from the reporting entity 19 and uses this information in its automatic trade execution process, described below. Data from the reporting entity 19 is also used to monitor prices of options on other markets 17, as well as that of stocks underlying the options to, among other functions, assess whether a “fast market” condition exists, that is, whether the other exchanges have indicated that due to the volume and/or price volatility of a security, certain of their normal trade execution rules will not apply.

The exchange 1 is also connected with a clearance entity 21. The clearance entity may be, for example, The Options Clearing Corporation (OCC). The clearance entity 21 performs the transactions necessary to clear the trade, including guaranteeing payment to the seller and accountability for the buyer.

Telecommunication links between the exchange and each of the entities 3-21 can be made by any of a number of known electronic data exchange mechanisms. For example, the exchange 1 may communicate to outside entities 3-21 via local area networks, wide area networks, direct electronic or optical cable connections, dial-up telephone connections, or a shared network connection including the Internet using wire and wireless based systems.

Data can be exchanged between the exchange 1 and entities 3-21 via data terminals located at the entities 3-21. Data terminals may be any of a number of known data processing machines, for example, computer workstations, personal computers, minicomputers, mainframe computers, personal digital assistants, web TV boxes, and the like. Terminals at the entities 3-21 include software capable of communication with the exchange 1 using a predetermined data format. According to one embodiment of the invention, data is exchanged with the exchange 1 using OMnet™ API software manufactured by OM Technology AB of Stockholm, Sweden. Data may also be communicated from members to the exchange through the use of third-party services 12 that connect to the exchange. According to the embodiment illustrated in FIG. 1, EAM 11 is connected with the exchange 1 via such a third party communication system 12. The third party communication system may be, for example, an independent order routing and back office service provider.

The exchange 1 may be implemented on a general-purpose computer under the control of a software program. According to one embodiment of the invention, the exchange 1 is implemented on an Open VMS system running the OM Click Exchange™ software manufactured by OM Technology AB. Alternatively, the exchange 1 can be implemented on a network of general-purpose computers each under the control of a separate software program or on a system of interconnected parallel processors. Although complex, it is believed that suitable software for performing the various functions described herein can be designed and constructed by computer programmers of ordinary skill.

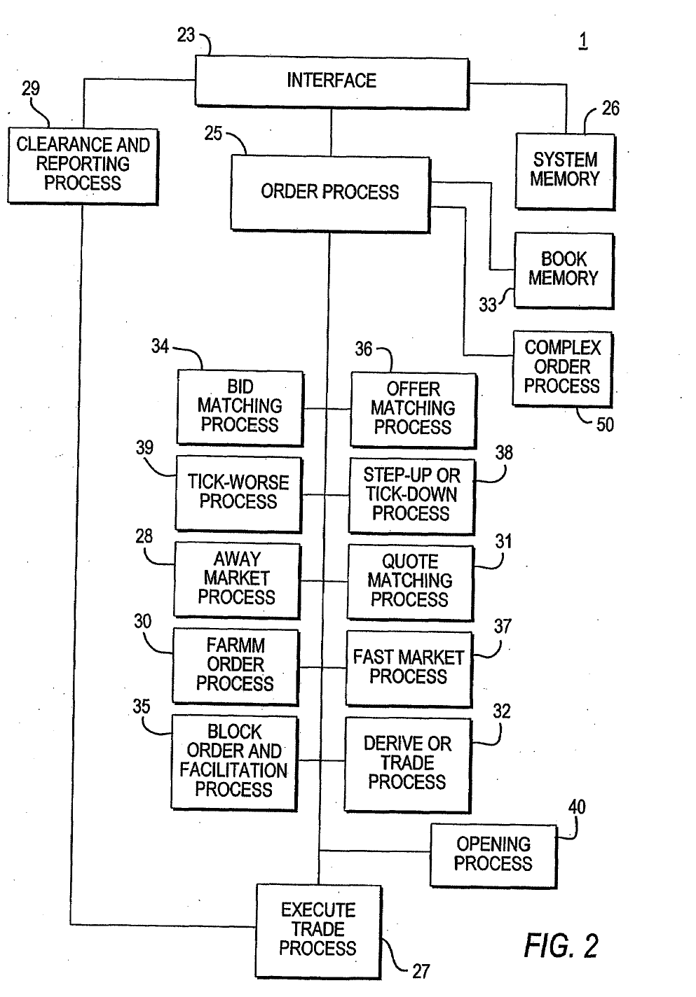

FIG. 2 shows the exchange 1 in detail. Connections between the exchange 1 and entities 3-21 are made via a data interface 23. The data interface 23 performs error checking, data compression, encryption and mediates the exchange of data between the exchange 1 and entities 3-21. Orders and quotations from the PMM 3 and CMMs 5,7, as well as orders entered by EAMs 9,11 are placed on the exchange 1 via the interface 23.

Order and quotation information received via the interface 23 from the PMM 3, CMMs 5,7 and EAMs 9,11 is sent to the order process 25. The order process 25 first checks to see if the order or quotation is valid according to programmable parameters that reflect the particular trading rules of the entity administrating the invention. For example, according to one embodiment of the invention, if the order were a market order placed by a professional the order would be rejected because trading rules prohibit professional market orders.

The order process 25 checks whether a fast market condition exists and, if so, passes orders to the fast market process 37. The fast market process 37 provides a mechanism to dampen volatility. If it is determined that the trading volume exceeds a certain amount or market volatility would lead to inequitable trades, the exchange 1 can be placed in fast market mode with respect to one or more instruments by storing a fast market parameter in the system memory 26. The fast market process 37 introduces a delay between trades that is determined by the administering entity and may be changed based upon the market conditions so that the appropriate interval can be employed. The fast market process 37 further determines an optimal price for executions based upon orders and quotes that accumulate during the delay, which will serve to dampen price fluctuations and execute trades at equitable prices. The exchange 1 automatically monitors price and volume data received from the reporting entity 19. When the primary market for the underlying stock indicates a fast market, the exchange 1 automatically sets a fast market condition for a predetermined time interval. The fast market process 37 is described in detail below.

The order process 25 varies depending upon whether the order is a public customer order, professional order, FARMM order, or complex order. Except in the case of a FARMM order or a complex order, discussed below, the order process 25 checks whether the incoming order can trade against orders and quotations in the book memory 33, that is, whether the terms of an order can be satisfied by a previously entered order or quotation in the book memory 33. For example, if there is an order to sell at 3 in the book memory 33, an incoming market order to buy, or an incoming limit order to buy with a stated price of 3, or higher can trade. If the incoming order can trade and the order is a public customer order, the order process 25 checks the price on the away market 17 as reported by the reporting entity 19 to determine if there is a better price available. Should an away market 17 have a better price for the incoming order, the order process 25 sends the order to the away market process 28.

The away market process 28 either trades the public customer order automatically against the PMM 3 at the same price as the better price in the away market 17 or else stores the order in the book memory 33 and alerts the PMM 3 to the order according to a set of predetermined parameters stored in the system memory 26 by the PMM 3. The order is stored in the book memory 33, but is hidden, i.e., the price of the order is not communicated to the reporting entity 19. The hidden order will be executed if an incoming order or quotation can be matched with the hidden order, the away market 17 no longer has a better price, or the PMM chooses to execute the order.

Where the order process 25 determines that there is not a better price in an away market 17, or where the order is a professional order, the incoming order is sent to the bid matching process 34 if it is an order to buy and the offer matching process 36 if it is an order to sell. The bid matching process 34 matches buy orders against orders and quotations to sell that are stored in the book memory 33. The offer matching process 36 matches incoming sell orders against orders and quotations to buy stored in the book memory 33. In both the bid matching process 34 and the offer matching process 36, public customer orders at the best price are executed in time priority before professional orders and quotations at the same price. After public customer orders in the book memory 33 are executed, the bid matching process 34 and the offer matching process 36 apply an algorithm that allocates the remaining size of an incoming order among the professional orders and quotations at the best price. This trade matching algorithm is described in detail below.

Where the order process 25 determines that an incoming limit order cannot trade against orders stored in the book memory 33, or if only a portion of the incoming order can trade, the order process 25 stores the incoming order or unexecuted portion thereof in the book memory 33 unless the order contains an instruction that it should be deleted if it cannot trade with orders in the book memory 33. For example, if the highest bid stored in the book memory 33 (the best bid) is 3 and the lowest offer stored in the book memory 33 (the best offer) is 4, an order to sell with a stated price of 4 cannot trade. If the incoming limit order that cannot trade improves the market, that is if the incoming order is a limit order with a bid price higher than the best bid stored in the book memory 33 or an offer price lower than the best offer stored in the book memory 33, and the size of the order is below a specified number of contracts, the order process 25 sends the order to the derive or trade process 32 if it is a public customer order, or deletes the order if it is a professional order. The derive or trade process 32 ensures that, when the market improving order is stored in the book memory 33, there is at least a minimum market size at the new market price. Under one embodiment of the invention, market rules require that there be at least 10 contracts available at the best price at all times. Thus, if the size of the market improving order is less than 10 contracts, the derive or trade process 32 either supplements the market-improving order with an order derived on behalf of the PMM 3 or else trades the market-improving order against the PMM's account. The order process 25 also sends a public customer order to the derive or trade process 32 if the aggregate size of the best price becomes less than the minimum market size. The derive or trade process 32 is described in detail below.

According to one embodiment of the invention, there are three instances where an incoming limit order that cannot trade is not stored in the book memory 33. First, a limit order may contain special instructions that it should not be stored in the book memory 33. For example, if a limit order is designated as a fill-or-kill order, the order process 25 will delete the incoming order unless the entire size of the order can be traded against the orders and quotations in the book memory 33. Second, if a limit order is designated as a immediate-or-cancel order, the order process 25 will delete any portion of the incoming order that cannot trade against the orders and quotations in the book memory 33. Finally, according to this embodiment, a professional limit order that cannot trade entirely at a price that is within two trading increments below the best bid or above the best offer is deleted by the order process 25, that is, no portion of the professional limit order is traded.

If an order is a FARMM order, the order process 25 sends the order to the FARMM order process 30. The FARMM order process 30 stores the order in a separate memory process and generates a message to the PMM 3 and CMMs 5,7 that a FARMM order has been received. The PMM 3 can determine to send the FARMM order to the bid matching process 34 or offer matching process 36, or the PMM 3 can determine to execute the FARMM order.

The order process 25 sends quotations to the bid matching process 34 or the offer matching process 36 if the quotation can trade with an order on the book memory 33. If a quotation would match against a quotation stored in the book memory 33, the order process 25 sends the quotation to the quotation matching process 31. If a quotation cannot trade, the order process 25 stores the quotation in the book memory 33. The quotation matching process 31 will not immediately execute an incoming quotation with a quotation that is stored in the book memory 33. Rather, according to one embodiment of the invention, the exchange 1 stores a programmable parameter that indicates the amount of time that the bid matching process 34 and the offer matching process 33 will wait before matching an incoming quotation with a quotation stored in the book memory 33. The quotation matching process is described in detail below.

Quotations entered by a PMM 3 or CMM 5,7 contain a size parameter table which instructs the order process 25 the percentage of the size of a quotation and the absolute number of contracts that should be made available to execute against professional orders or quotations, and that percentage of the size of a quotation and the absolute number of contracts that should be made available to execute against FARMM orders. For example, a PMM 3 that enters a quotation to buy 60 contracts at 4, can indicate in the quotation size parameter table that the lesser of 50% of the size of the quotation or 20 contracts should be made available to be executed against a professional order or quotation and that only 25% or 35 contracts should be made available to be executed against FARMM orders. In this example, the PMM's quotation can be executed against at 4 by professional orders for a total of 20 contracts (the lesser of 50% of 60 and 20) and executed against at 4 by FARMM orders for a total of 15 contracts (the lesser of 25% of 60 and 35 contracts). The PMM will never execute more than 30 contracts total at 4, so that if the size of the quotation is reduced to 15, the PMM's quotation can not be executed against by any type of order for more than 15 contracts. If the size available for execution against a professional order or quotation or the size available to execute against a FARMM order is reduced to zero, the order process will initiation the tick-worse process 39 if a professional order or quotation or FARMM order attempts to match at the quotation price.

The block order and facilitation process 35 is an optional process that an EAM 9,11 can choose to use when executing large-size orders. The size of an order eligible for the block order and facilitation process is variable and can be set by the entity administering the exchange 1. Block orders are sent by the order process 25 to the block order and facilitation process 35. The block order and facilitation process 35 sends a message containing certain information describing the order to the PMM 3 and CMMs 5,7, as well as to EAMs 9,11 with proprietary orders at the best price. The block order and facilitation process 35 allows those participants that received the message to enter individual bids or offers against the block order in the form of anonymous messages that are stored in a separate memory function, that is, such messages do not interact with orders and quotations stored in the book memory 33 and are not part of the bid matching process 34 or offer matching process 36. Because block trade information sent to participants does not include the entering broker or customer information, the party placing the block trade maintains anonymity, and because the messages are not communicated outside of the system, the participants that respond with bids and offers maintain anonymity.

Parties receiving the block order information respond within a limited time period with bid and offer messages. At the expiration of the time period, the block order and facilitation process 35 calculates the best possible execution price for the block order and allocates the block order among the responders, as well as orders and quotations stored in the book memory 33, according to the algorithm contained in the bid matching process 34 and offer matching process 36. Block orders must contain a stated price. A block order may be designated as a fill-or-kill order, that is, a trade should take place only if the entire size of the order can be executed at the stated price of the order or better. If no trade is possible at the stated price or better, or if there is insufficient volume to execute the entire size of an order that is designated fill-or-kill, the block order and facilitation process 35 deletes the block order and any responses. If only a portion of a block order that is not designated fill-or-kill is executed, the block order and facilitation process 35 deletes the unexecuted portion of the block order and any unexecuted responses.

A facilitation order is a block order that the entering EAM 9,11 wishes to trade against its own proprietary order. Facilitation orders entered into the block order and facilitation process 35 are handled the same as block orders as described above, except in the case of a facilitation order, the block order and facilitation process 35 uses an algorithm that allocates all or a portion of the facilitation order against the EAM 9,11 that entered it. Further, in the case of a facilitation order, the order is always executed in full because the EAM 9,11 entering the order commits to executing any amount of the order that is not executed by other participants. The block and facilitation process 35 is described in detail below.

Complex orders are sent to the complex order process 50. Operation of the complex order process 50 is described in detail below.

Orders and quotations that have been executed are sent to the execute trade process 27. The execute trade process 27 instructs the order process 25 to remove the matched order from the book memory 33, and sends a message to the participants that submitted the matched orders or quotations. The execute trade process 27 also sends trade information to the clearance and reporting process 29. The clearance and reporting process 29 sends the executed trade information to the reporting entity 19 and the clearance entity 21 via the interface 23.

The final two process in FIG. 2 are the tick-worse process 39 and the step-up or tick-worse process 39, both of which apply to quotations entered by a PMM 3 or CMMs 5,7. The tick-worse process 39 automatically changes the price and size of a quotation in the book memory 33 when the size of the quotation in the book memory 33 is reduced to zero. The tick-worse process 39 determines the new price and size according to parameters entered by the PMM 3 or CMM 5,7. These parameters are stored in the system memory 26 with respect to each quotation entered by a PMM 3 or CMM 5,7. The new quotation price is one or more trading increments lower for a quotation to buy and one or more trading increments higher for a quotation to sell. The step-up or tick-down process 38 increases the size of a quotation at the best price when the aggregate size of the best price would be less than the minimum market size according to parameters entered by the PMM 3 or CMM 5,7, or sends the quotation to the tick-worse process 39. The tick-worse process 39 and the step-up or tick-down process 38 are described in detail below.

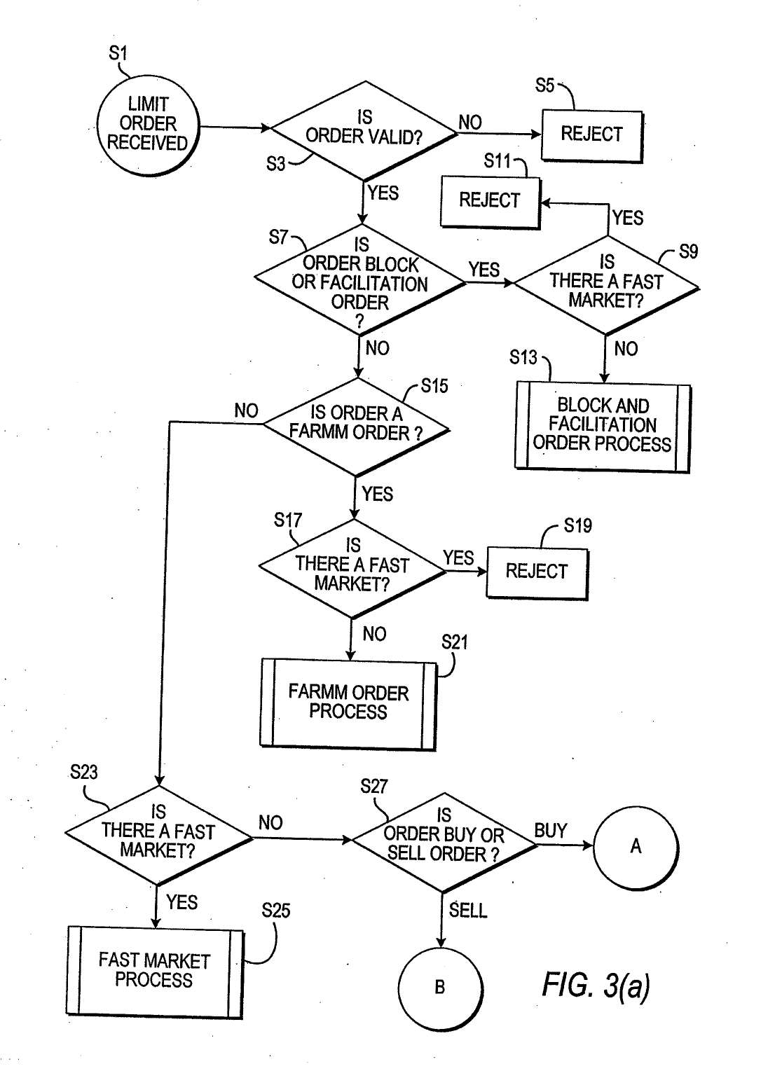

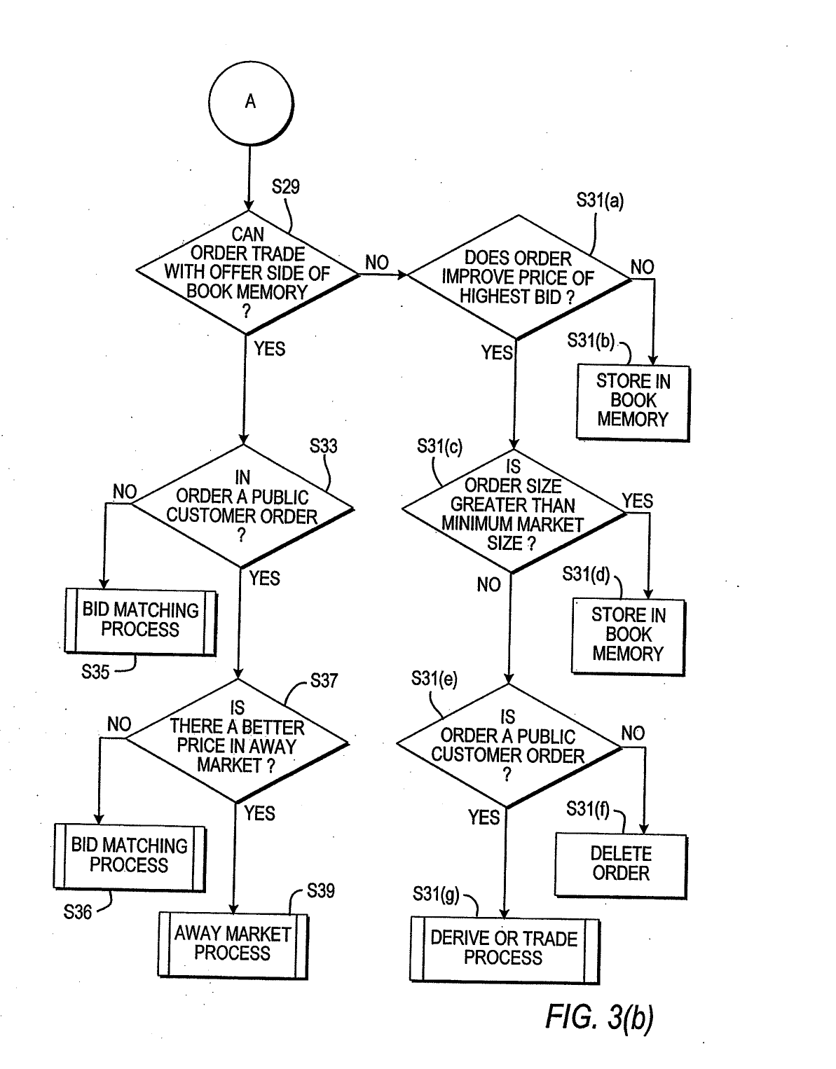

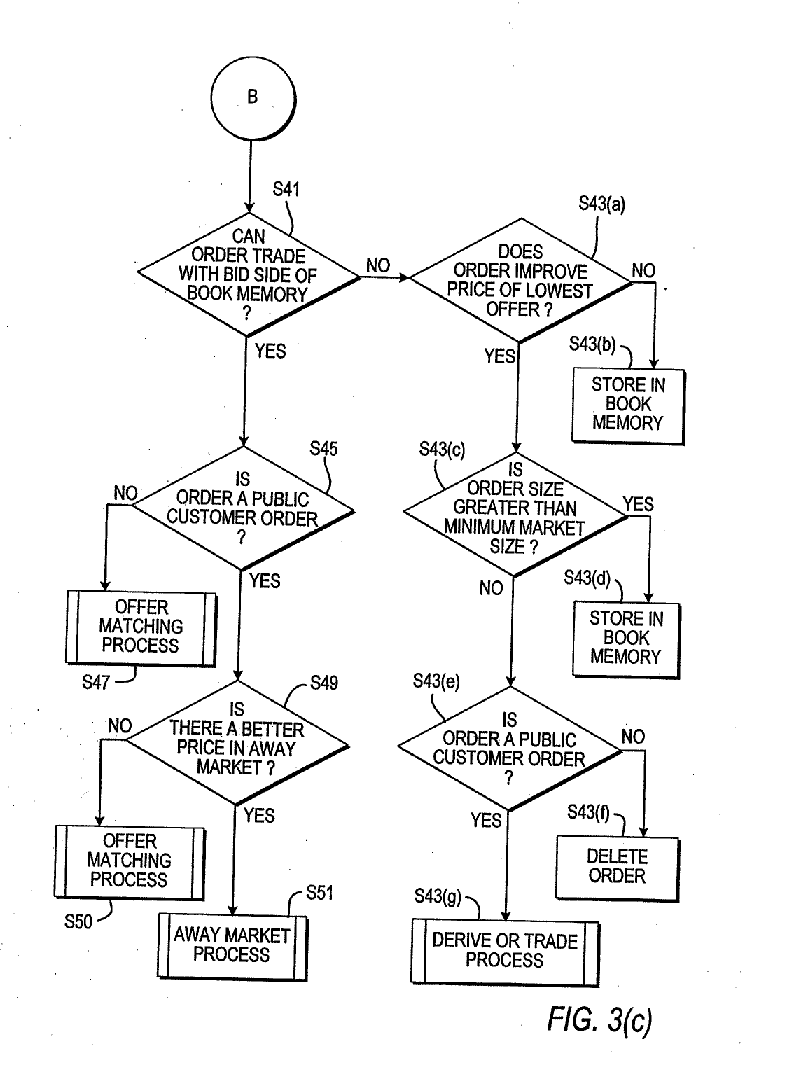

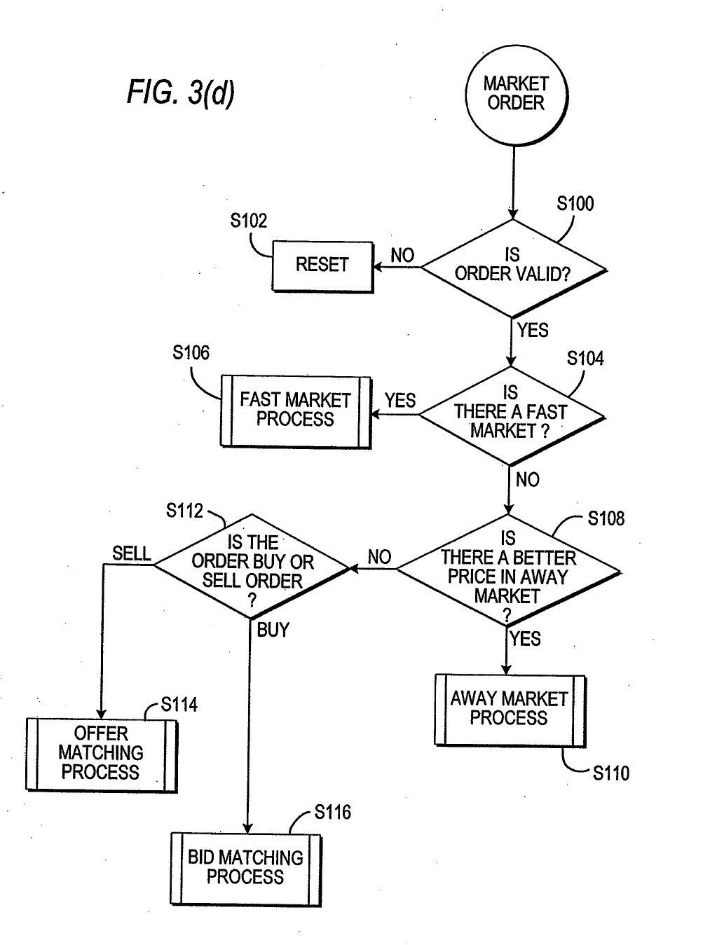

FIGS. 3(a) through 3(c) illustrating the trading process within the exchange 1 for a limit order. An order is received at step S1 by the interface 23 and passed to the order process 25. At step S3 of FIG. 3(a), the order process 25 determines whether the incoming order is valid. If the incoming order is not valid, the order process 25 rejects the incoming order at step S5 and sends a message to the party placing the incoming order indicating that the order was rejected.

If the order is valid, then the order process 25 determines at step S7 whether the order is a block or a facilitation order. If the order is either of these, the order process 25 determines at step S9 whether the exchange is in a fast market mode, and if it is, the order process 25 rejects the incoming order at step S11 and sends a message to the party placing the incoming order. If the exchange is not in a fast market mode, the block order and facilitation process 35 is initiated at step S13.

If the incoming order is not a block order or a facilitation order, the order process 25 determines at step S15 whether the order is a FARMM order. If the order is a FARMM order, the order process 25 determines at step S17 whether the exchange is in a fast market mode, and if it is, the order process 25 rejects the incoming order at step S19 and sends a message to the party placing the incoming order. If the exchange is not in a fast market mode, the FARMM order process 30 is initiated at step S21.

If the incoming order is not a FARMM order, the order process 25 determines at step S23 whether the exchange is in a fast market mode, and if it is, the order is handled according to the fast market process 37 at step S25. If the exchange is not in fast market mode, the order process 25 determines at step S27 whether the incoming order is an order to buy or to sell.

If the incoming order is an order to buy, the order process 25 determines at step S29 of FIG. 3(b) whether the incoming order can trade with the offer side of the book memory 33. If the order cannot trade at step S29, the order process 25 determines at step S31(a) whether the order would improve upon the best bid, that is, whether the price of the order is higher than the highest order or quotation to buy stored in the book memory 33, and if it is not, the order process 25 stores the order in the book memory 33 at step S31(b). If the order would improve upon the best offer, the order process 25 determines at step S31(c) whether the size of the order is equal to or greater than the minimum market size stored in the system memory 26, and if it is, stores the order in the book memory 33 at step S31(d). If the order is less than the minimum market size, the order process 25 determines at step S31(e) whether the order is a public customer order, and if it is not, deletes the order at step S31(f). If the order is a public customer order the order process 25 sends the order to the derive or trade process 32 at step S31(g).

If the incoming order can trade with the offer side of the book memory 33 at step S29, the order process 33 determines at step S33 whether the order is a public customer order, and if it is not, the bid matching process 34 is initiated at step S35. If the incoming order is a public customer order, the order process 25 determines at step S37 whether there is a better offer in the away market 17, and if there is not, the bid matching process 34 is initiated in step S36. If there is a better price in the away market at step S37, the order process 25 sends the order to the away market process 28 at step S39. The order process 25 will skip step S37 and send the order directly to the bid matching process 34 if the away market process 28 has been disabled at the exchange.

If the incoming order is an order to sell at step S27, the order process 25 determines at step S41 of FIG. 3(c) whether the incoming order can trade with the bid side of the book memory 33. If the order cannot trade at step S41, the order process 25 determines at step S43(a) whether the order would improve upon the best offer, that is, whether the price of the order is lower than the lowest order or quotation stored in the book memory 33, and if it is not, the order process 25 stores the order in the book memory 33 at step S43(b). If the order would improve upon the best offer, the order process 25 determines at step S43(c) whether the size of the order is equal to or greater than the minimum market size stored in the system memory 26, and if it is, stores the order in the book memory 33 at step S43(d). If the order is less than the minimum market size, the order process 25 determines at step S43(e) whether the order is a public customer order, and if it is not, deletes the order at step S43(f). If the order is a public customer order the order process 25 sends the order to the derive or trade process 32 at step S43(g).

If the incoming order can trade with the bid side of the book memory 33 at step S41, the order process 33 determines at step S45 whether the order is a public customer order, and if it is not, the offer matching process 36 is initiated at step S47. If the incoming order is a public customer order, the order process 25 determines at step S49 whether there is a better bid in the away market 17, and if there is not, the offer matching process 36 is initiated in step S50. If there is a better price in the away market at step S49, the order process 25 sends the order to the away market process 28 at step S51. The order process 25 will skip step S49 and send the order directly to the offer matching process 36 if the away market process 28 has been disabled at the exchange.

FIG. 3(d) illustrates the trading process within the exchange 1 for a market order. A market order is received at step S 100. The order process 25 determines at step S100 whether the order is valid, and if it is not, rejects the order at step S102. If the order is valid, the order process 25 determines at step S104 whether the exchange is in fast market mode, and if it is, sends the order to the fast market process 37 at step S106. If the exchange is not in fast market mode, the order process 25 determines at step S108 whether there is a better price in an away market 17, and if there is, sends the order to the away market process 28. If there is not a better price in an away market 17, the order process 25 determines at step S112 whether the order is to buy or sell. If the market order is a sell order, the order process 25 sends the order to the offer matching process 36 at step S114. If the market order is a buy order, the order process 25 sends the order to the bid matching process 34 at step S116. The order process 25 will skip step S108 and move directly to step S112 if the away market process 28 has been disabled by the exchange.

### Trade Matching

The exchange 1 according the to the invention matches incoming orders with orders and quotations stored in the book memory 33. The order process 25 initiates the bid matching process 34 and the offer matching process 36, which contain rules that give priority to public customer orders at the best price, then allocates any remaining part of an incoming order or quotation among the professional orders and quotations on a pro rata basis. Specifically, incoming orders that match a public customer order on the book are traded first against the public customer order. If more than one public customer order is on the book at the same price, priority is assigned on the basis of entry time and trades are done on a first in, first serve basis. That is, public customer orders received earliest are traded first.

Limit orders that cross over the best price on the book will trade at the best price to the extent of the size on the book at the best price. For example, if the best order or quotation to buy in the book memory 33 is 4 for a total size of 20, a limit order to sell 10 at a stated price of 3½ will match at 4. Where the incoming order is greater than the size of the orders and quotations on the book at the best price, the bid matching process 34 and the offer matching process 36 will, using the priority rules discussed in the previous paragraph, first trade the incoming order against the orders and quotations at the best price and then trade the balance of the incoming order against the orders and quotations on the book at the next worse price. The process will continue until there is no more volume left in the incoming order, or there is no longer an order or quotation in the book memory 33 that can match the price of the incoming order. If there is still volume left in the incoming order and all orders and quotations on the book that can match the incoming order have been filled, the remaining volume of the incoming order is placed in the book memory 33, and this order sets a new best price.

Where both public customer orders and professional orders and quotations are at the best price the bid matching process 34 and offer matching process 36 first fills the public customer orders. If the incoming order is below a predetermined size, for example, 5 contracts, then after public customer orders have been filled, the PMM 3 will trade exclusively the remaining size of the order if it has a quotation in the book memory 33 at the best price. When the incoming order is for more than the predetermined PMM small order preference size, the bid matching process 34 and the offer matching process 36 allocate the trade among the professional orders and quotations at the best price according to an algorithm stored in the system memory 26.

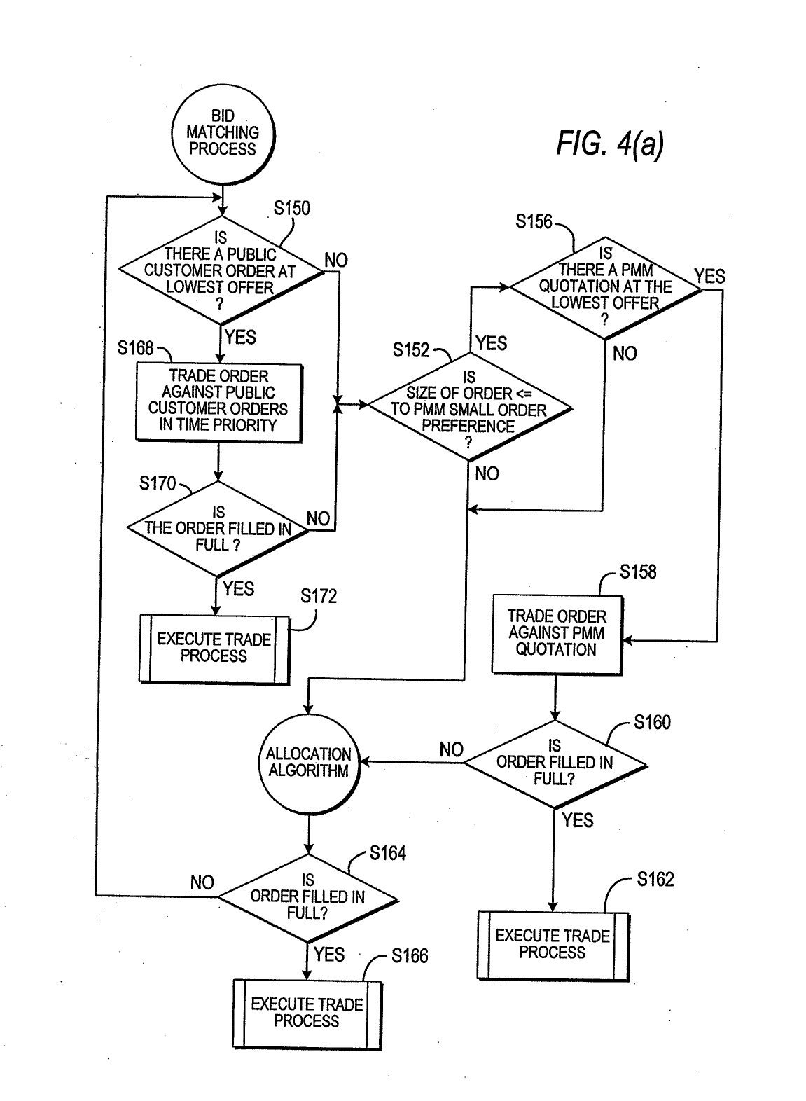

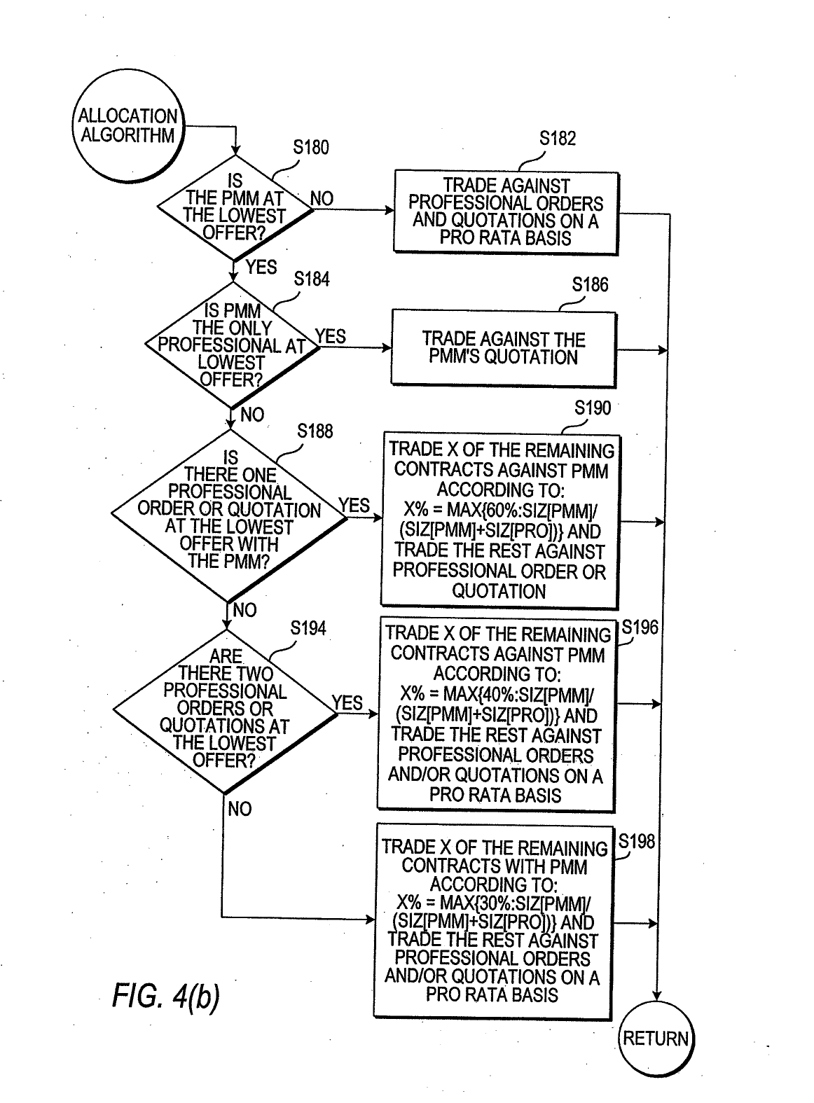

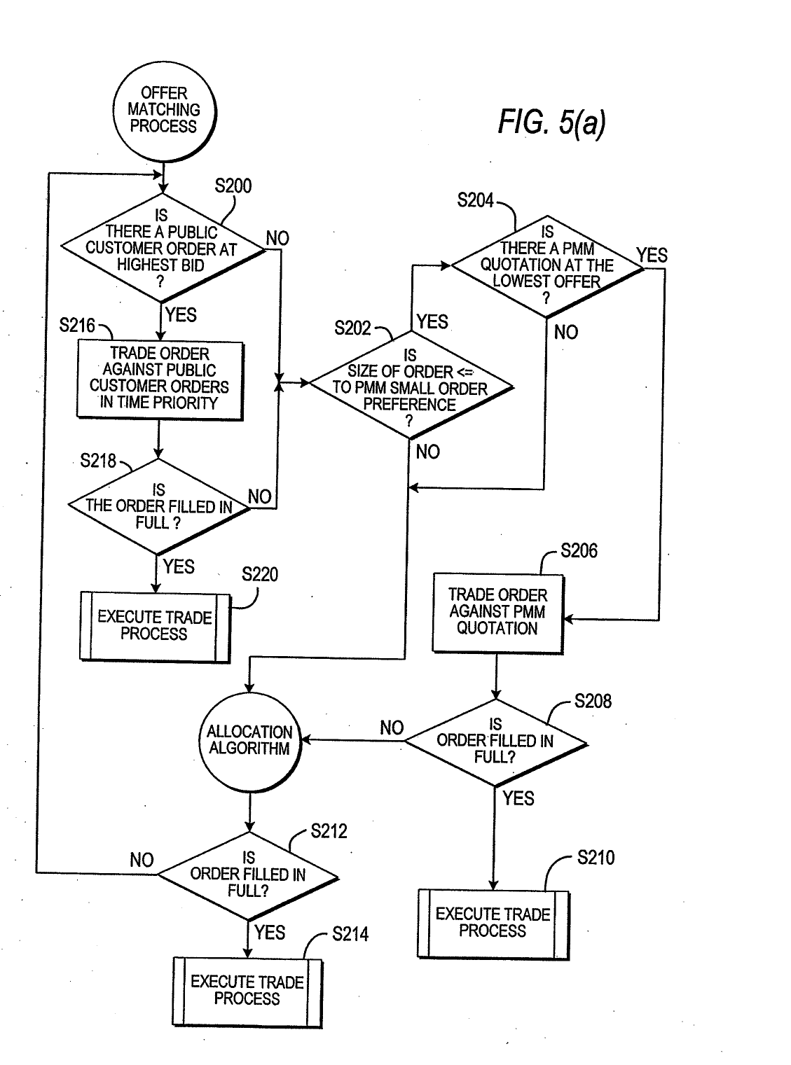

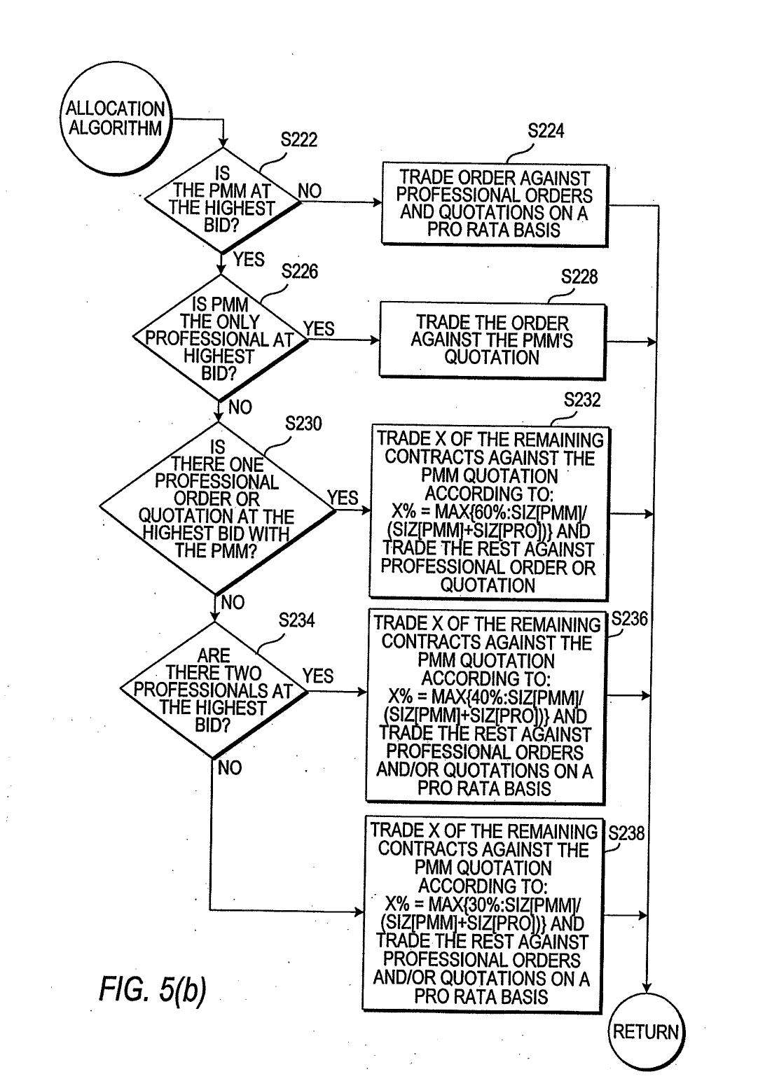

FIGS. 4(a)-4(b) illustrate an embodiment of bid matching according to the invention. FIGS. 5(a)-5(b) illustrate an embodiment of offer matching according to the invention. The operation of bid and offer matching will be described in terms of a number of examples of incoming orders made against orders and quotations stored in the book memory 33. For these examples it is assumed that the incoming orders are not block or facilitation orders and no fast market condition exists. Further, it is assumed that there are no better prices on away markets 17.

TABLE I

| BID | | | | | OFFER | | | | |
|---|---|---|---|---|---|---|---|---|---|
| | | | | Price | Price | | | PRO | |
| CUS | PRO #1 | PMM | Total | ($) | ($) | Total | CUS | #1 | PMM |
| | 10 | 10 | 20 | 3 | 3½ | 35 | 10 | 5 | 20 |
| 10 | 20 | | 30 | 2½ | 3¾ | 10 | | 10 | |

Table I shows an example of a portion of the book stored in the book memory 33. As shown in Table I, a total of 20 contracts have been bid at 3 and a total of 30 contracts have been bid at 2½. PRO #1, a professional, for example, an EAM 9,11 trading on its own account, has entered an order to buy 10 contracts at 3 and the PMM 3 has placed a quotation to buy 10 contracts at 3. A public customer 13,15 (CUS) has entered an order to buy 10 contracts at 2½ and PRO #1 has entered an order to buy 20 contracts at 2½. The best bid price is 3.

On the offer side of the book, a public customer has entered an order to sell 10 contracts at 3½. PRO #1 has placed an order to sell 5 contracts at 3½ and 10 contracts at 3¾. The PMM 3 has entered a quotation to sell 20 contracts at 3½. The best offer price is 3½.

As a first example, assume that an incoming order to buy 4 contracts at 3½ is sent to the bid matching process 34 by the order process 25. The bid matching process 34 determines at step S150 of FIG. 4(a) that there is a public customer order at the lowest offer. The bid matching process 34 trades the incoming order to buy 4 contracts with the public customer order in the book memory 33 at step S168. At step S170, the bid matching process determines that all 4 contracts in the incoming order have be matched. The match between the incoming order and the customer order in the book memory 33 is sent to the execute trade process 27 in step S172.

As a second example, assume the same book as shown in Table I and an order to buy 30 contracts at 3½ is sent to the bid matching process 34. As shown in FIG. 4(a), the bid matching process 34 completes step S168 as above, matching 10 contracts of the incoming order with the public customer order to sell 10 contract at 3½. At step S170, however, the bid matching process 34 determines that there are still 20 contracts of the incoming order remaining and therefore moves to step S152. At step S152, the bid matching process 34 determines that the original size of the incoming order was greater than the PMM small order preference size, which is assumed to be 5 contracts for the purpose of this example. The bid matching process then applies the allocation algorithm as illustrated in FIG. 4(b).

FIG. 4(b) shows an allocation formula for matching incoming orders against quotations and professional orders at the best price, i.e., the lowest offer. According to this example, steps S180, S184 and S188 determine that there is one professional along with the PMM at the best price. According to one embodiment of the invention at step S190, the balance of the incoming order of 20 contracts is allocated among the PPM 3 and PRO#1 according to the following formula:

X%=max[60%,siz[pmm]/(siz[pmm]+siz[pro])] Equation #1

Where:

siz [pmm] is the size of the quotation for the PMM 3 at the market price; and

siz [pro] is the size of the order for the professional, PRO #1, at the market price.

If X % would result in a fractional allocation, the number allocated is rounded up to the nearest whole number. Other allocation formulas are also possible without departing from the scope of the invention. For example, a minimum percentage greater or smaller than 60% may be selected. Also, the allocations may not be a “straight-line” pro rata formula but may include weighting factors. According to Equation #1, the PMM 3 is entitled to trade 80% of the remaining 20 contracts in the incoming order, i.e., the maximum of 60% and (20/(20+5))=80%. Thus, 16 of the remaining 20 contracts are traded against the PMM's quotation and 4 are traded against PRO # 1's order at step S190 of FIG. 4(b). The bid matching process 34 determines at step S164 of FIG. 4(a) that the order has been completely filled and sends the matches to the execute trade process 27.

As a third example, assume that the book memory 33 is as it appears in Table I and a limit order to sell 16 contracts at 3 is sent to the offer matching process 36 by the order process 25. The offer matching process 36 determines at step S200 of FIG. 5(a) that there are no public customer orders at the highest bid price of 3. The offer matching process 36 determines at step S202 that the original size of the incoming order was greater than the PMM small order preference size, which is assumed to be 5 contracts for the purpose of this example, and moves to apply the allocation algorithm. FIG. 5(b) contains a diagram of the same allocation formula discussed above in connection with the bid matching process 34 as applied in the offer matching process 36. At step S222 of FIG. 5(b), the offer matching process determines that the PMM has a quotation at 3 and at steps S226 and S230, that there is one other professional order or quotation, PRO #1, at the same price. The incoming order is allocated according to Equation #1 in step S232. The PMM trades 60% of the order of 16 contracts, rounded up to the next whole contract, or 10 contracts. PRO #1 trades the remaining 6 contracts. In step S212 of FIG. 5(a), the offer matching process 35 determines that the entire order was matched and sends the matches to the execute trade process 27 at step S124.

TABLE II
OFFER

| Price | Total | CUS | PRO #1 | PRO #2 | PMM |
|---|---|---|---|---|---|
| 2½ | 50 | | 10 | 20 | 20 |
| 2¾ | 30 | 10 | 10 | | 10 |

Table II shows another example of the book. For clarity only the offer side of the book is shown. Two professionals, PRO #1 and PRO #2, have placed orders along with the PMM 3 quotation and a public customer order to sell. Assume that the order for PRO #1 at 2½ was placed before the order for PRO #2 at 2½, so that PRO #1 has time priority at the lowest offer of 2½. As a fourth example, assume that an incoming customer limit order to buy 10 contracts at 2½ is enter on the exchange 1.

The bid matching process 34 proceeds as shown in FIGS. 4(a) and 4(b). The process moves through steps S150 and S152 shown in FIG. 4(a), and steps S180, S184, S188 and S194, shown in FIG. 4(b) as described in the third example discussed above, to determine that there are two professional orders at 2½ along with the PMM's quotation. At step S196 the incoming order is allocated among the PMM 3, PRO #1, and PRO #2. According to one embodiment, the following equation is used to allocate the order among the PMM 3 and the two professionals:

X%=Max[40%,Siz[pmm]/(Siz[pmm]+Siz[pro])] Equation #2

Where:

siz [pmm] is the size of offer of the PMM 3 at the market price; and siz [pro] is the size of the combined orders of the two professionals.

If X % would result in a fractional allocation, the number allocated is rounded up to the nearest whole number. Other allocation formulas are possible without departing from the scope of the invention. For example, a minimum percentage greater or smaller than 40% may be used. Further, the pro rata allocation can be modified by, for example, weighting factors that favor PRO #1 or PRO #2. According to Equation 2, the PMM 3 is entitled sell 40% of the 10 contracts against the incoming order, or 4 contracts. The remainder of the order is filled by the professionals, PRO #1 and PRO #2 on a pro rata basis. Although PRO #1 has time priority, PRO #2 has a greater size, so his share is computed first. PRO # 2 has 20 out of the 30 contracts of the orders placed by the two professionals at the lowest offer and is entitled to 66% of the 6 remaining contracts, or 4 contracts. The remaining 2 contracts are traded by PRO #1.

TABLE III
BID

| CUS | PRO #1 | PRO #2 | PRO #3 | PMM | TOTAL | PRICE |
|---|---|---|---|---|---|---|
| 3 | 20 | 20 | 10 | 10 | 63 | 3 |
| 10 | 20 | | | | 30 | 2½ |

Table III shows yet another example of the bid side of the book stored in the book memory 33, showing that three professionals, PRO #1, PRO #2, and PRO #3, have placed orders to buy along with a public customer order and the PMM 3 quotation at the highest bid price of 3. The three professionals PRO #1, PRO #2 and PRO #3 are listed in order of time priority.

As a fifth example, assume a public customer limit order to sell 49 contracts at 3 is entered. The offer matching process 36 proceeds as shown in FIGS. 5(a) and 5(b). The offer matching process 36 determines at step S200 that there is a public customer order at the highest bid and matches 3 contracts of the incoming order against the CUS order at step S216. The offer matching process moves to step S218 and determines that there remains 46 contracts in the incoming order, then moves to step S202 to determine that the original size of the order is greater than 5 contracts, which is the PMM small order preference size for the purposes of this example. The offer matching process 36 then applies the allocation formula and completes steps S222, S226, S230 and S234 in FIG. 5(b) as explained in previous examples, to determine that there are more than two professionals with orders or quotations along with the PMM 3 quotation at the highest bid price. Step S238 allocates the remaining 46 contracts among the PMM 3 and the three professionals. According to one embodiment, the order is allocated according to the following formula:

X%=Max[30%,Siz[pmm]/(Siz[pmm]+Siz[pro])]. Equation #3

Where:

siz [pmm] is the size of the bid of the PMM 3 at the market price; and

siz [pro] is the size of the combined orders of the three professionals.

If X % would result in a fractional allocation, the number allocated is rounded up to the nearest whole number. Other allocation formulas can be used. For example, a minimum percentage greater or smaller than 30% can be used or weighting factors can be provided to adjust the allocation among the professionals based. According to Equation 3, the PMM 3 is entitled to 14 contracts, however, the PMM's bid is for only 10 contracts at a price 3. Therefore, the PMM 3 trades only 10 contracts at 3 against the incoming order. The balance of 36 contracts are allocated among the three professionals on a pro rata basis. In this case, PRO #1 and PRO #2 have the same size, which is greater than PRO #3. Because PRO #1 has time priority over PRO #2, PRO #1 gets matched first. PRO #1 has 40% of the orders among the professionals (20/50) and is entitled to 15 contracts, leaving 21 contracts. PRO #2 has now has the largest size and 66% of the size at the highest bid (20/30) and is matched for 14 contracts, leaving 7 contracts. PRO #3, the last remaining professional, trades the balance of 7 contracts.

The examples given here are by way of illustration only. No limitation of the invention should be implied.

### Tick-Worse Process

The tick-worse process 39 according to the present invention allows the PMM 3 and CMMs 5,7, to specify a set of quotations that are automatically entered when the size of a quotation in the book memory 33 is reduced to zero. Each quotation placed by the PMM 3 and CMMs 5,7 is associated with a quotation table for moving quotations one or more trading increments worse than the best price, a worse price being a lower price than a previously entered quotation to buy and a higher price than a previously entered quotation to sell. Table IV is an example of such a quotation table. The quotation table specifies variable volumes at which the PMM 3 and CMMs 5,7 are willing to trade at successively lower bids or higher offers. Because this process is automatic, continuous quotations are maintained in the book memory 33 without a delay between an execution and the PMM 3 and CMMs 5,7 manually entering another quotation.

TABLE IV

| | |
|---|---|
| Initial Size | 30 contracts |
| 1-tick worse | 10 contracts |
| 2-ticks worse | 30 contracts |
| 3-ticks worse | 0 contracts |
| 4-ticks worse | 60 contracts |
| 5-ticks worse | 60 contracts |
| 6-ticks worse | 60 contracts |
| 7-ticks worse | 60 contracts |
| 8-ticks or more worse | 100 contracts |

It is to be understood that the quotation table shown in Table IV is by way of example only. A limitless number of quotation tables may be specified without departing from the scope of the invention. Further, each PMM 3 or CMM 5,7 can specify a quotation table for each quotation entered.

In this example, the PMM 3 has placed an initial quotation for 30 contracts shown in the first line of Table IV and has specified a range of quotation sizes to be quoted when the initial quotation is exhausted. The table is stored in the system memory 26 and is retrieved by the tick-worse process 39 when needed. The depth of the table and the number of contracts for each tick level can be adjusted by the PMM 3. When the initial quotation for 30 contracts, as shown in the first line of Table IV, is exhausted, the tick-worse process 39 automatically generates a new quotation for 10 contracts at a price one tick worse than the market price. If the initial order for 30 contracts were placed at a market price of 3, then after these contracts are traded, the tick-worse process 29 automatically generates a new quotation for 10 contracts at 2 15/16 (assuming that below 3 the minimum trading increment is 1/16). When the market at the price one tick worse becomes exhausted, the tick-worse process 39 enters a quotation for 30 contracts at a price two ticks worse than the original quotation and so on.

TABLE V
BID

| CUS | PRO | PMM | TOTAL | PRICE |
|---|---|---|---|---|
| 3 | | 30 | 33 | 3 |
| | | | | 2 15/16 |

Table V shows an example of the bid side of the book in which a public customer has entered an order to buy 3 contracts at 3 and the PMM 3 has entered a quotation to buy 30 contracts at 3. The PMM 3 has stored the table shown in Table IV in the system memory 26. Assume that a market order is received offering to sell 40 contracts. The order is passed to the offer matching process 36 as shown in FIGS. 5(a) and 5(b) after completing all necessary steps in FIG. 3(d) to reach S114. After steps S200 and S216 of FIG. 5(a), the incoming public customer order is matched for 3 contracts with the public customer order in the book memory 33 at the highest bid price of 3, leaving 37 contracts of the incoming market order unmatched in step S218. After step S202, the offer matching process 36 applies the allocation formula according to FIG. 5(b) and completes steps S222 and S226, matching the PMM's quotation for 30 contracts at 3 in step S228, and leaving 7 contracts of the incoming market order unmatched.

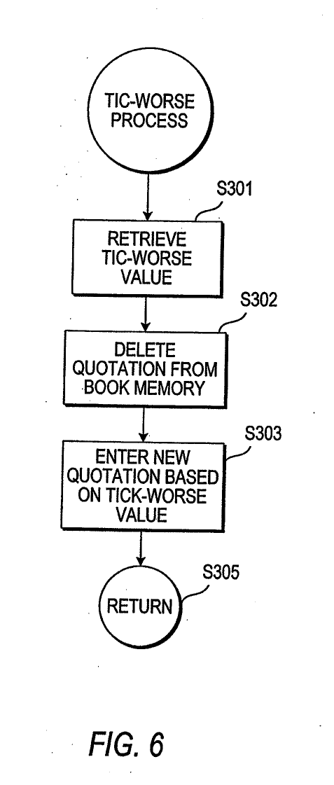

Because the full size of the PMM's quotation at 3 has been exhausted, the tick-worse process 39 is initiated as illustrated in FIG. 6. The tick-worse process 39 automatically retrieves a tick-worse value from the system memory 26 in step S301. The tick-worse value depends on the number of times the PMM 3 has been ticked down after placing the quotation with which the tick-worse table is associated. Here, since this is the first time the PMM 3 has been ticked down, a tick down value of 10 contracts is retrieved based on the table shown in Table IV. The PMM's quotation at 3 is deleted from the book memory 33 in step S302 and a new quotation for the PMM 3 is automatically entered in the book memory 33 at a price one tick worse than the deleted quotation. Thus, a quotation for 10 contracts at 2 15/16 is placed for the PMM 3 at step S303. At step S305 the process returns to step S212 in FIG. 5(a) and the offer matching process 36 continues at step S200, only now the highest bid is 2 15/16. The process moves through steps S202 and applies the allocation formula according to FIG. 5(b), matching the remaining 7 contracts against the PMM's new quotation at 2 15/16 that was generated by the tick-worse process 39 in step S303 above.

TABLE VI
OFFER

| PRICE | TOTAL | CUS | PRO #1 | PMM |
|---|---|---|---|---|
| 3½ | 60 | | 30 | 30 |
| 3⅝ | 5 | 5 | | |

Table VI shows an example of the offer side of the book As a further example, assume that a market order to buy 75 contracts is entered. Assume also that both the PMM 3 and PRO #1, who is a CMM 5, 7 that has entered a quotation, have each entered the same quotation table shown in Table IV along with their initial quotations of 30 contracts.

The bid matching process 34 proceeds through steps S150 and S152 shown in FIG. 4(a), as described in previous examples, and applies the allocation formula according to FIG. 4(b). Both of the quotations from the PMM 3 and PRO # 1 are exhausted at 3½, leaving 15 contracts of the market order unmatched. The tick-worse process 39 retrieves the tick-worse values for both the PMM 3 and PRO #1 in step S301 of FIG. 6, and deletes the quotations at 3½ from the book memory 33 in step S302. In step S303, the tick-worse process automatically enters new quotations for the PMM 3 and PRO #1 at the price of 3⅝ for 10 contracts each (assuming that above 3, the minimum trading increment is ⅛). At step S305 the process returns to step S164 in FIG. 4(a) and the offer matching process 36 continues, only now the lowest offer is 3⅝. The process moves to step S 168 and matches 5 contracts against the public customer order to sell at 3⅝, and then moves through step S152 to apply the allocation formula, completing steps S180, S184 and S188 to match the remaining 10 contracts in step S196 according to FIG. 4(b).

### Step-Up or Tick-Worse Process

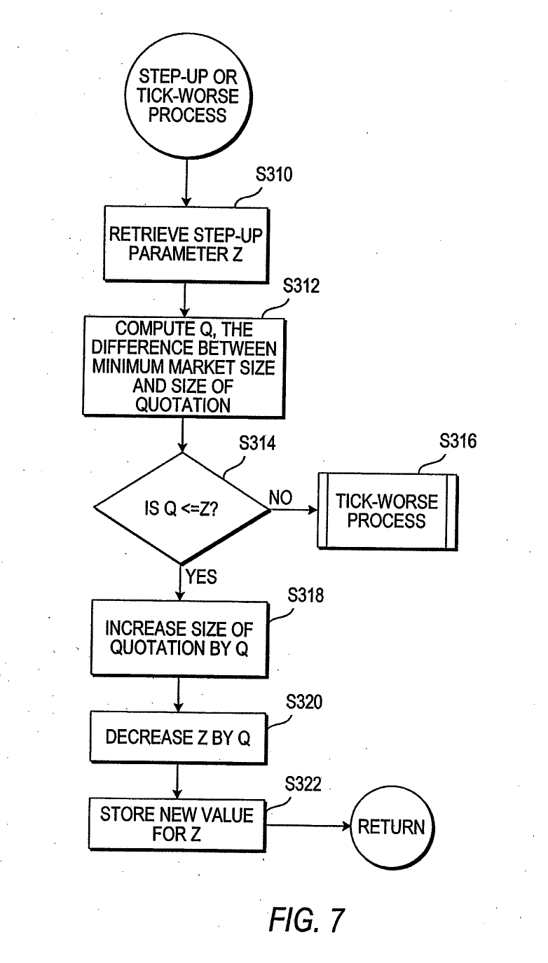

FIG. 7 illustrates the step-up or tick-worse process 38. The step-up or tick-worse process 38 is initiated when there is a PMM 3 or CMM 5,7 quotation at the best price and the size of the best price in the book memory 33 becomes less than the minimum market size set in the system memory 26. The PMM 3 or CMM 5,7 sets a parameter Z of a certain number of contracts with respect to each quotation entered. At step S310, the step-up or tick-worse process 38 retrieves the Z parameter, and at step S312, calculates Q, which is the difference between the minimum market size and the size of the quotation at the best price at step S312. At step S314 the step-up or tick-worse process 38 determines whether there is sufficient size in the Z parameter, that is whether Q is less than or greater than Z. If Q is greater than Z, the step-up or tick-worse process 38 initiates the tick-worse process 39 at step S316. If Q is equal to or less than Z, the size of the quotation is increase by Q at step S318, which results in the size of the quotation becoming equal to the minimum market size. Z is then decreased by Q at step S320, and the new value for Z is stored in the system memory 26 in step S322.

TABLE IX
BID

| CUS | PRO | PMM | TOTAL | PRICE |
|---|---|---|---|---|
| | | 10 | 10 | 3 |
| 10 | 20 | | 30 | 2½ |

As another example of the step-up or tick-worse process 38, Table IX shows an example of the bid side of the book. Assume a market order to sell 6 contracts is entered. The exchange 1 trades all 6 contracts in the market order against the PMM's quotation at 3 in the manner discussed with reference to FIGS. 5(a) and (b). A total of 4 contracts at the market price of 3 remain in the PMM's quotation. Assuming a minimum market size of 10 contracts, the step-up or tick-worse process 38 will either step-up the PMM's quotation to 10 contracts or initiate the tick-worse process 39 as described above. At step S312 Q is determined to be 6 (10−4). Step S314 determines whether the PMM 3 will be stepped up or ticked down by comparing Q with the Z. If Z=7 then, since Z is greater than Q, the PMM's quotation is stepped up by 6 contracts at step S318, Z is reduced to 1 in step S320, and the resulting market has a total of 10 contracts at the price of 3. The resulting book is as shown in Table X.

TABLE X
BID

| CUS | PRO | PMM | TOTAL | PRICE |
|---|---|---|---|---|
| | | 10 | 10 | 3 |
| 10 | 20 | | 30 | 2½ |

If however, Z=5, then since Z is less than the step-up size of 6, and the PMM 3 will be ticked-down according to the tick-worse process 39 initiated in S316.

### Derive or Trade Process

The exchange 1 according to one embodiment of the present invention maintains a minimum size at the best bid and best offer, referred to herein as X. The value of X is variable and may be change in the system memory 26. According to one embodiment of the invention, the minimum market size X is 10 contracts. When an incoming public customer limit order that cannot trade improves the market (that is, when an order to buy at a price higher than the best bid in the book memory 33 or an offer to sell at a price lower than the best offer in the book memory 33) and the size of the order is less than 10 contracts, the order process 25 sends the order to the derive or trade process 32 at step S43(g) of FIG. 3(c) if it is an order to sell and at step S31(g) of FIG. 3(b) if it is an order to buy. If an incoming professional order or quotation improves the best price for less than 10 contracts, it is deleted according to steps S43(f) of FIG. 3(c) and S31(f) of FIG. 3(b).

The derive or trade process 32 will either automatically match an incoming public customer order that improves the market for fewer than 10 contract at the order's stated price, or else derive an order for the PMM 3 at the stated price of the order so that the size at the best price will be 10 contracts. Whether an order is automatically traded or whether an order is derived is determined by a parameter stored in the system memory 26. A variable Y, the number of contracts the PMM 3 is willing, to have derived based on how much an order improves the market is entered by the PMM 3. According to one embodiment, Y can be determined using a matrix functionality shown in Table VII.

TABLE VII

If improvement = 1/16 then Y = 9
If improvement = ⅛ then Y = 7
If improvement = 3/16 then Y = 4
If improvement = ¼ then Y = 2

The functionality of Table VII is based on the assumption that the further away a market improving order is from the PMM's quotation price, the more willing the PMM 3 will be to trade it rather than join it with a derived order. According to one embodiment of the invention, a market-improving order is traded away or joined with a derived order using the following formula.

If (X minus Siz[limit orders])>Y then trade against the public customer order;

If (X minus Siz[limit orders])<=Y then derive (X minus Siz[limit order]) for the PMM 3 at the new market price,

where X=minimum market size; and

Siz[limit orders]=total number of limit order contracts at the market improving price.

The PMM's derived order is only good as long as the public customer incoming order that caused it to be created remains active. If the market-improving public customer limit order is canceled or traded in full, the derived order is removed. If the market-improving public customer order is partially traded, the derived order may increase, or the balance of the market-improving customer order may be executed automatically. When new orders are placed on the book at the same price as the PMM's derived order, these new orders reduce the derived order size to minimize the number of derived order contracts necessary to maintain the minimum market size.

TABLE VIII

| | |
|---|---|
| BID | OFFER |

| Cust | PRO | PMM | Total | Price | Price | Total |
|---|---|---|---|---|---|---|
| 3 | 10 | 30 | 43 | 3 | 3¼ | 30 |
| 10 | | | 10 | 2¼ | 3½ | 20 |

Table VIII shows an example of bids and offers stored in the book memory 33. Assume a public customer limit order to buy 2 contracts at 3⅛ is entered. Step S29 of the bid matching process 34 shown in FIG. 3(b) determines that this order cannot trade because there are no offers to sell at less than 3¼. Step S31(a) determines that this bid would improve the market if it were entered on the book since the highest bid price is currently 3. Entering the order on the book at 3⅛ would improve the market by raising the market bid price. After determining that the order size is less than the minimum market size (assumed to be 10 contracts) at step S31(c) and that the order is a public customer order at step S31(e), the derive or trade process 32 is started at step S31(g).

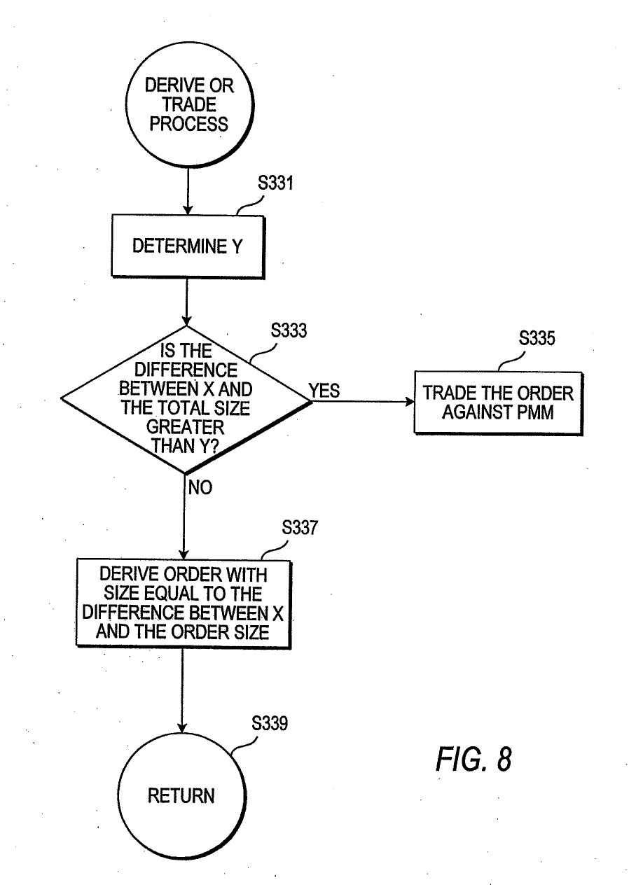

The operation of the derive or trade process 32 is shown in FIG. 8. Step S331 determines the maximum derived order size, Y, allowed by the PMM 3 from the matrix provided by the PMM 3 stored in the system memory 26. Since this bid improves the market by ⅛, from 3 to 3⅛, the value of Y from Table VII is 7. Step S333 determines that the difference between the minimum market size, 10, and the incoming order 2 is, 10−2=8, which is greater than Y=7. Step S335 automatically trades the incoming order against the PMM 3 at 3⅛. The best bid price remains 3.

As a further example, assume the same book as in Table VIII. A public customer order for 4 contracts at 3⅛ is entered. Now the derive or trade process 32 at step S333 in FIG. 8 determines that the difference between the minimum market, 10, and the order size 4 is, 10−4=6, which is less than Y=7. Step S337 derives an order for the PMM 3 at 3⅛ for 6 contracts to provide a minimum market of 10 contracts at the new price of 3⅛. The public customer order at 3⅛ will always trade before the derived order. If the customer order for 4 contracts is executed in full, the derived order at 3⅛ will be deleted, and the book memory 33 will return to its state in Table VIII. If the public customer order is reduced by an execution, for example, to 2 contracts, the derive or trade process 32 will return to step S333 and determine that the difference between the minimum market, 10 and the remaining order size 2 is, 10−2=8, which is greater than Y=7. The remaining portion of the order will be executed automatically against the PMM 3 at step S335.

The determination of the maximum derived order size, Y, can be made using means other than the functionality shown in Table VII. According to one embodiment of the invention, Y depends on the absolute market price as well as on the price improvement of the incoming order.

The derive or trade process 32 will also be initiated if the best price become less than 10 contracts. For example, again assume the market illustrated in Table VIII, if the PRO order is cancelled and the PMM 3 moves its quotation to 2¼, the bid at 3 would be reduced to only the public customer order for 3 contracts. The derive or trade process 32 would be initiated by the order process, and an order would be derived for 7 contracts in step S333 as described in the previous example. Moreover, if a professional order for fewer than 10 contracts became the best bid in a similar manner to this example, the order would be automatically deleted. The step-up or tick-worse process 38 would be initiated if a quotation for fewer than 10 contracts were to be the become the best bid, as described above.

### Match of an Away Market Price

According to an embodiment of the invention, prior to executing an incoming public customer order at the best price in the book memory 33, the order process 25 compares the best price in the book memory to prices quoted for the same option on the away market 17. If the price on the exchange 1 is as good as or better than the price on the away market 17, the trade is executed. If the price on the away market 17 is better than the best price on the exchange 1, the away market process 28 is initiated.

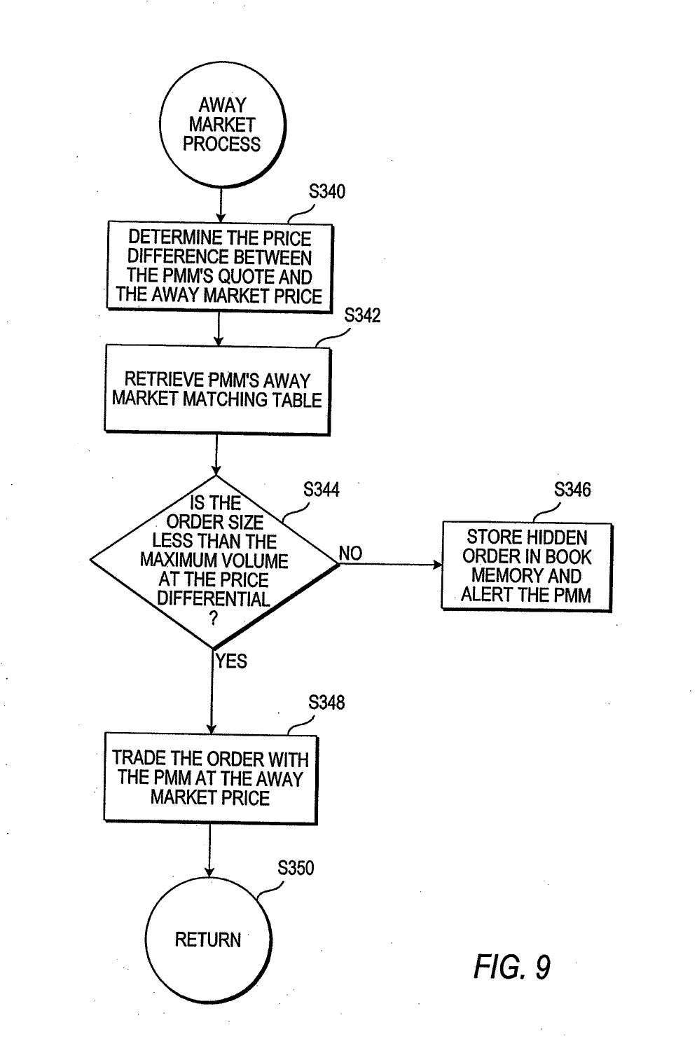

The operation of the away market process 28 is illustrated in FIG. 9. The away market process 28 first determines the price difference between the PMM's quotation in the book memory 33 and the away market price at step S340. According to one embodiment of the invention, the away market process 28 receives price information from the reporting entity 19. Step S342 retrieves the PMM's away market matching table from the system memory 26. Table XI shows an example of such a table.

TABLE XI

| If away market is better by | PMM matches up to ?? contacts |
|---|---|
| <=.0625 | 15 |
| <=.1250 | 10 |
| <=.1875 | 5 |
| <=.2500 | 2 |
| <=.3125 | 1 |
| <=.3750 | 1 |
| <=.4375 | 0 |

The away market matching table determines a matching size that is the number of contracts that the PMM 3 is willing to execute at the better price equal to the away market for a range of price differentials between the PMM's quotation and the away market 17 According to one embodiment of the invention, the away market matching table is arranged so that the PMM 3 is more likely to change his price to execute a public customer order at the better away market price where the price differential between the PMM's quotation and the away market 17 is small. Where a large price differential exists, the PMM 3 will only trade small orders or will decline to match automatically. At step S344 the volume of the incoming order is compared with the maximum volume for the price differential given in the away market matching table. If the volume of the order is less than tae volume of the order shown in the away market matching table, then step S348 automatically trades the order against the PMM 3 at the away market price. If the volume of the incoming order is greater than the volume given by the away market matching table, then step S346 alerts the PMM 3 of the price differential between the exchange 1 and the away market 17. The PMM 3 can then decide whether to trade the incoming order at the away market price.

If an order is not traded automatically by the PMM 3 in step S348, the order is stored in the book memory 33, but is not displayed as the best price. Rather, the order is hidden, but remains available for execution. For example, if the best bid in the book memory 33 is 4 and the best offer is 4¼, and the best bid from another market is 4⅛, a public customer order to sell at 4 that is stored at step S346 may be executed against an incoming market order or limit order to buy at 4¼, or higher. In this example, both the public customer order to sell at 4 and the order to buy received a better price.

### Fast Market Process

When the market for an options contract becomes highly volatile or when the rate at which orders are received becomes too great, it is possible that the best price in the book memory 33 will not accurately reflect the true price of the market. In such situations a fast market can be initiated by the entity administering the exchange 1 by setting a fast market parameter in the system memory 26. The exchange 1 also may monitor information received from the reporting entity 19 and automatically initiate a fast market condition is such a condition is indicated for the security underlying an option.

As shown in FIG. 3(a), the order process 25 checks whether a fast market condition exists at steps S9, S17 and S23 by checking the value of the fast market parameter stored in the system memory 26 If a fast market condition exists, the incoming order is rejected at step S11 if it is a block order or a facilitation order, and at step S19 if it is a FARMM order, otherwise the order is sent to the fast market process 37. The fast market process 37 accumulates orders for a time period determined by the value of the fast market parameter. At the end of this time period, a trade is executed at a price calculated to clear a maximum number of orders at a single price. After the trade, incoming orders are once again accumulated for the time period and again trade at the end of the time period. This process provides an equitable price for market orders by preventing orders received within aa short period of time from being traded at varying prices. The delay introduced by the fast market process also serves to dampen price fluctuations. Table XII shows an example of a range of delay time periods that can be set depending on the degree of volatility in the fast market according to one embodiment of the invention. Depending on the level of price volatility and/or trading volume, the fast market level can be adjusted to provide the desired degree of damping.

TABLE XII
FAST MARKET DELAY TIMES

| Fast Market Level | Delay |
|---|---|
| 0 | Normal Market - no delay |
| 1 | 20 seconds |
| 2 | 30 seconds |
| 3 | 40 seconds |
| 4 | 50 seconds |
| 5 | 60 seconds |
| 6 | ISE staff enters the number of seconds at the |
| | time the fast market is called |

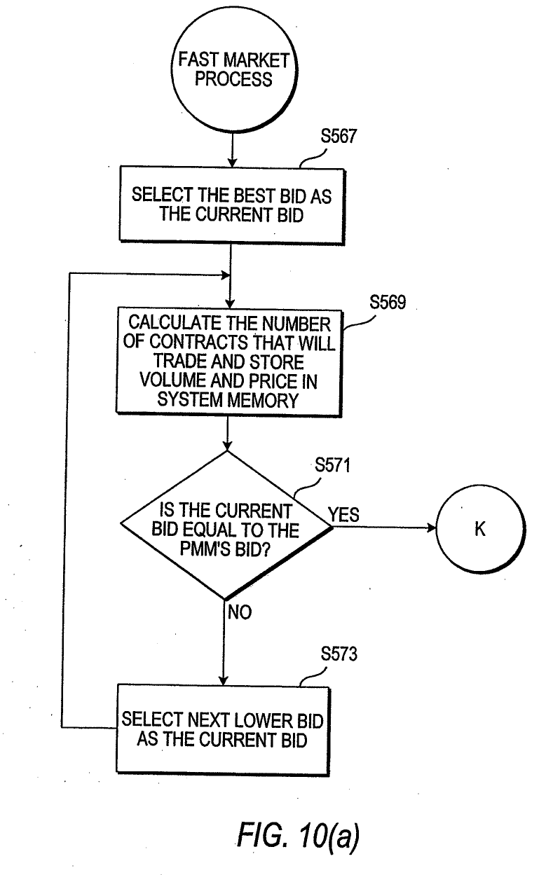

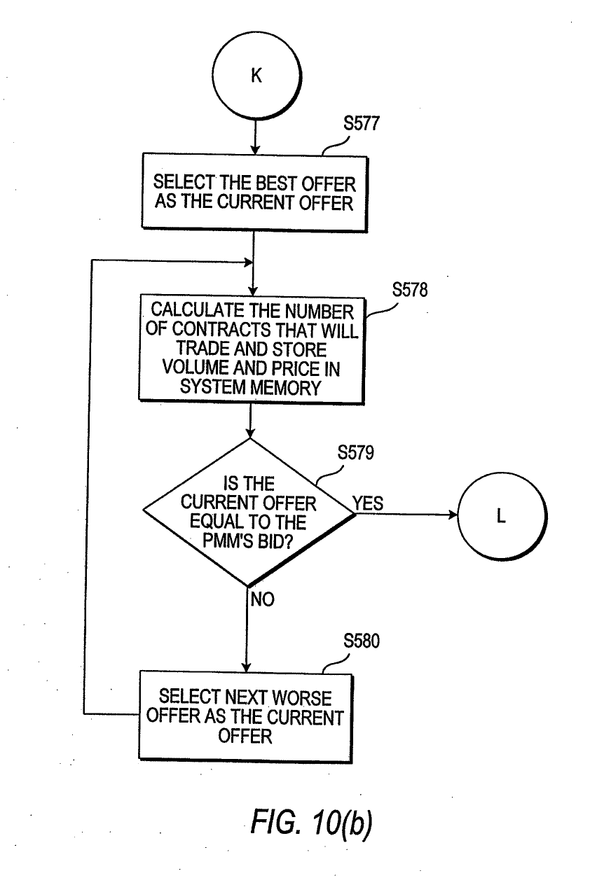

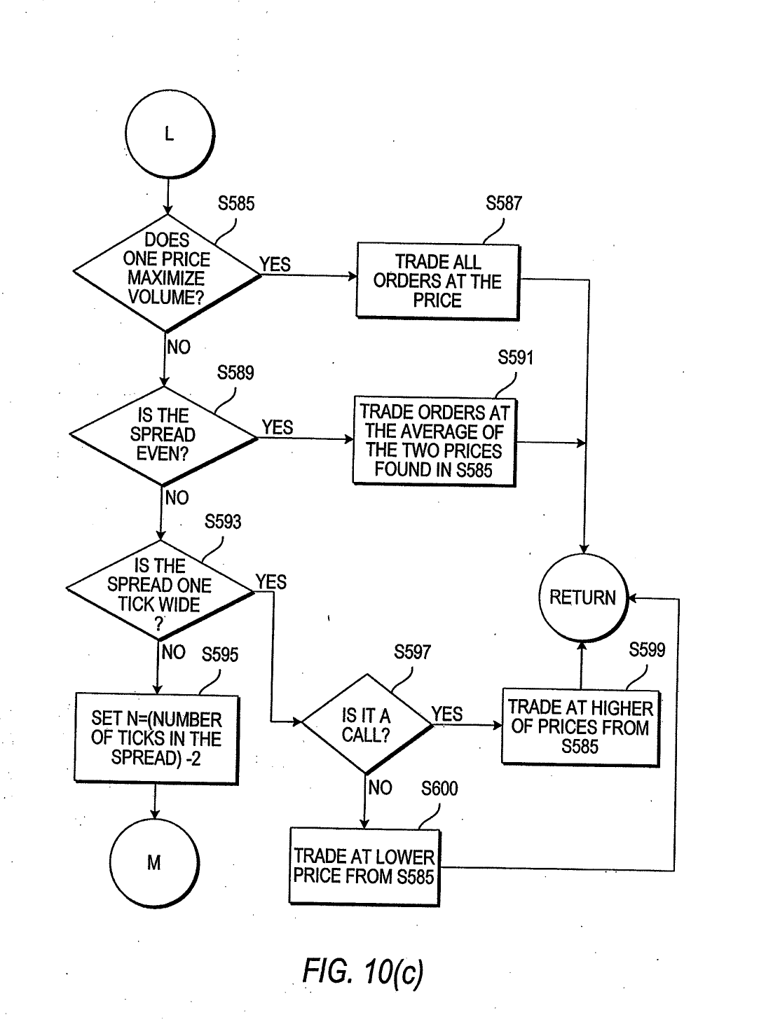

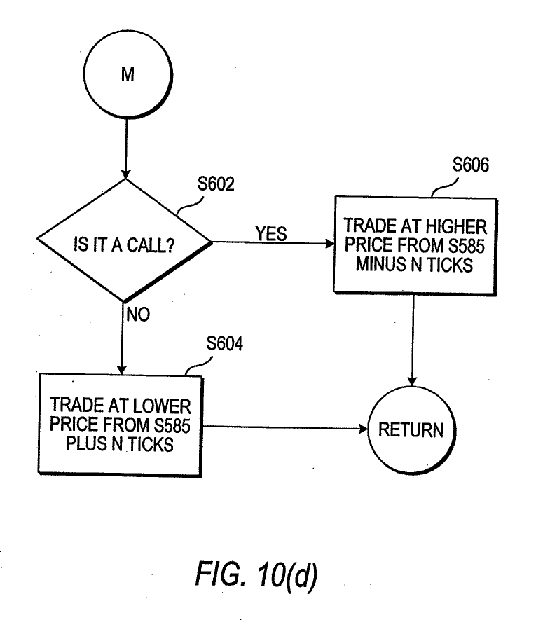

The operation of the fast market process 37 is illustrated in FIGS. 10(a) through 10(d) Step S567 shown in FIG. 10(a) selects the best (highest) bid in the book memory 33 as the current bid. Step S569 calculates the number of contracts that would trade at the current bid. Step S571 determines whether the current bid is equal to the PMM's bid. If not, step S573 selects the next lower bid and begins step S569 again. If the PMM's bid has been reached, step S571 moves the process to step S577 in FIG. 10(b), which selects the best (lowest) offer in the book memory 33 as the current offer. Step S578 calculates the number of contracts that would trade at the current offer. Step S79 determines whether the current offer is equal to the PMM's offer. If not, step S580 selects the next higher bid and begins step S578 again. If the PMM's offer has been reached, step S579 moves the process to step S585 in FIG. 10(c).

If there only one price that maximizes the number of contracts that can be traded, step S585 trades orders at that price. If both the current bid and current offer prices will lead to the same maximum number of contracts traded, then step S589 determines whether the spread between the current bid and offer prices is an even number of ticks. If it is, orders are traded at the average of the current bid and current offer prices at step S591. If the spread is not even in step S589, the process stores a variable N, which equals the number of ticks (i.e., trading increments) in the spread minus two, and moves to step S595. If the spread is one tick wide in step S593, the process determines whether the instrument is a put option or a call option. If it is a put option, step S600 trades the orders at the lower off the prices determined in S585. If it is a call option, step S599 trades the orders at the higher of the prices determined in Step S585.

Where the process moves to step S602 in FIG. 10(d), it determines whether it is a call option or a put option. If it is a put option, orders are traded at the lower of the prices determine in S585 plus N ticks in step S604, and if it is a call option, orders are traded at the higher price determined in S585 minus N ticks in step S606.

### Opening Process

The opening process 40 is initiated by the PMM 3 to trade orders and quotations accumulated when the exchange 1 is not executing trades, e.g., overnight. The opening process 40 employs the same process as the fast market process 37 described above and illustrated in FIGS. 10(a) through 10(d) with one modification. Prior to moving to steps S587 or S589 of FIG. 10(c), the opening process 40 determines whether there would be any market or marketable limit order left unexecuted at the maximum price or prices. If there would not be, the opening process 40 moves to steps S587 or S589, if the there would be unexecuted market orders, the opening process moves back to step S567.

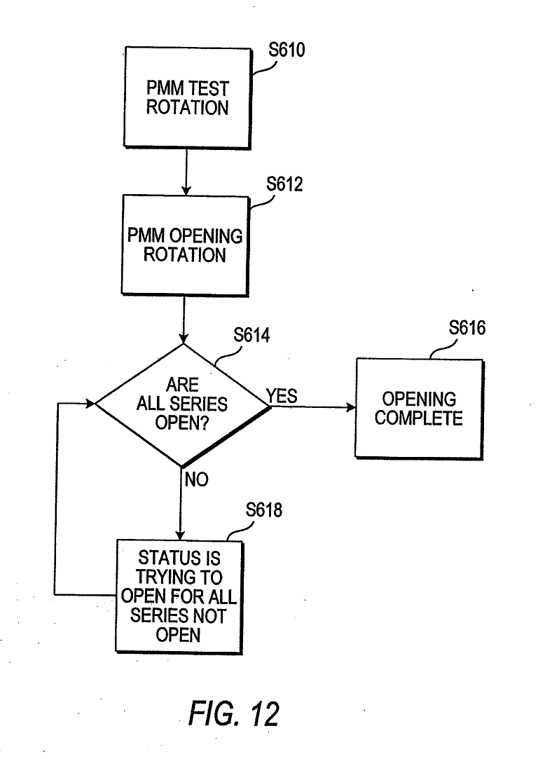

FIG. 12 illustrates how a PMM 3 initiates the opening process. In step S610, the PMM sends a message to the exchange 1 requesting that the opening process 40 test whether the opening process 40 would result in a single price where all market orders are executed as described above. The PMM 3 then instructs the exchange 1 to initiate the opening process 40. If all of the series of an options class are able to complete the opening process 40, the opening of the options class is complete. Any options series that could not complete the opening process 40 continues to attempt to complete the process as described with reference to FIGS. 10(a)-10(d).

### Block Order and Facilitation Process

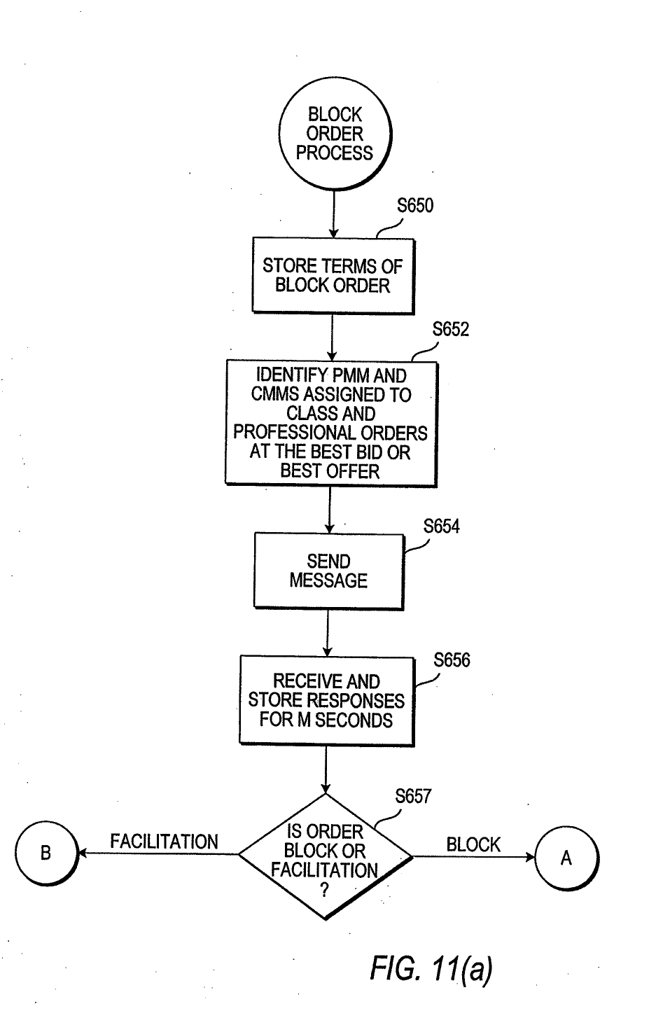

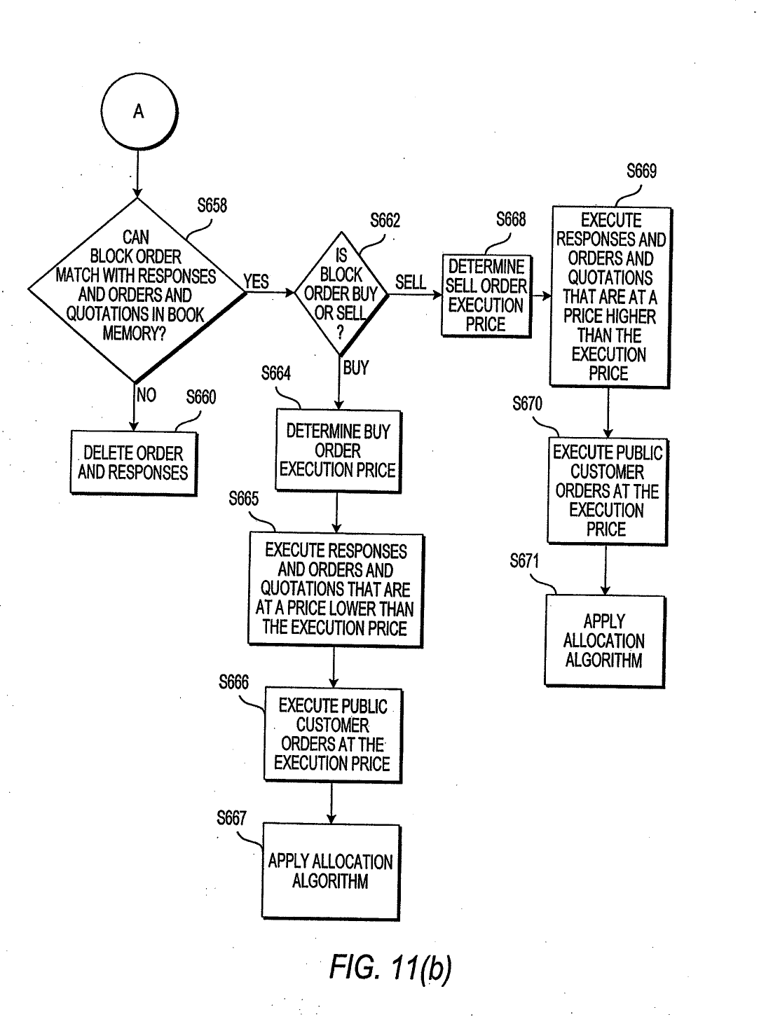

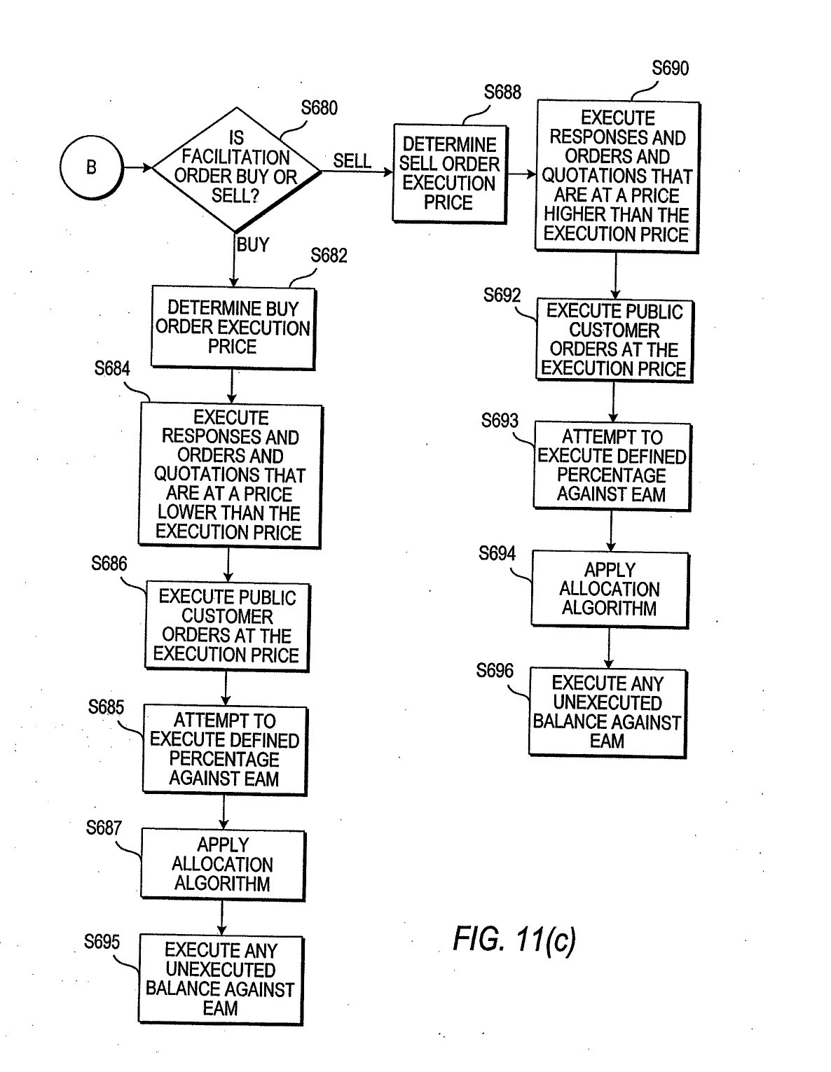

The block order and facilitation process 35 is initiated in step S13 of FIG. 3(a). FIGS. 11(a) through 11(c) illustrate the block order and facilitation process 35 when an order is received in step S650. The block order and facilitation process 35 identifies in step S652 the PMM and CMMs assigned to the option from information stored in the system memory 26 and those participants with professional orders at the best bid or best offer for the option. The block order and facilitation process 35 then sends a message in step S654 to those participants identified in step S652 informing them that a block order or facilitation order has been received. In the case of a block order, the message only includes the information about the order that EAM 9,11 that entered the order determined should be disclosed. For example, the EAM 9,11 could determine that the message should not contain information regarding the size of the order or the price of the order or both.

The participants that receive the message in step S654 are given M seconds in which they can choose to respond to the message with bids and offers in step S656. M is a preprogrammed parameter stored in the system memory 26 that may be varied as determined by the entity administering the exchange 1. At the end of M seconds, the block order and facilitation process 35 determines in step S657 whether the order is a block order or a facilitation order.

If the order is a block order, step S658 of FIG. 11(b) determines whether a trade can take place, that is whether a block order to sell can be matched with responses to buy and/or buy orders and quotations in the book memory 33, and whether a block order to buy can be matched with responses to sell and/or sell orders and quotations in the book memory 33. If the block order can trade, step S662 sends buy orders to step S664 and sell orders to step S668, where the execution price of the block order is determined. If the order is a facilitation order, step S680 determines whether the order is a buy order or a sell order, and sends buy orders to step S682 and sell orders to step S688, where the execution price of the facilitation order is determined.

The execution price of a block order or facilitation order determined in steps S664 and S682 will be the price of the order unless the entire size of the order can be executed at a lower price. The execution price of a block order or facilitation order determined in steps S668 and S688 will be the order price unless the entire size of the order can be executed at a higher price. If there are participants that are willing to sell at a price that is lower than the execution price of a block order or facilitation order to buy, such participants are executed at the execution price in steps S665 and S684, and if there are participants willing to buy at prices higher than the execution price of a block order or facilitation order to sell, such participants are executed at the execution price in steps S669 and S690. Public customer orders at the execution price are executed in steps S666, S670, S686 and S692.

The allocation algorithm described in FIG. 4(b) is applied at steps S667 and S687 and the allocation algorithm described in FIG. 5(b) is applied in steps S671 and S694 For the purposes of the allocation algorithm illustrated in FIGS. 4(b) and 5(b), responses received in step S656 are treated the same as professional orders and quotations.

TABLE XIII
OFFER IN BOOK MEMORY

| Price | Total | CUS | PRO #1 | PRO #2 | PMM |
|---|---|---|---|---|---|
| 2½ | 60 | 10 | 10 | 20 | 20 |
| 2¾ | 10 | | 10 | | 10 |

Table XIII shows an example of the book memory 33. As an example of the block order and facilitation process 35, a block order is entered by an EAM 9, 11 to buy 500 contracts at 2½. The EAM 9, 11 indicates when entering the order that the size of the order should not be revealed, only that the block order is to buy at 2½. After completing steps S3, S7 and S9 of FIG. 3(a), the block order is sent to the block order and facilitation process 35 where the terms of the order are stored in S650 and a message is sent to the PMM 3, PRO #1, PRO #2 and any CMMs associated with the options class in the system memory 26. PMM 3 responds that it is willing to sell 250 contracts at 2½ and PRO #1 responds that it is willing to sell 210 contracts at 2½. No other responses within 30 seconds, are received, which is the assumed value of M for the purposes of this example.

The block order and facilitation order process 35 determines that the order is a block order in step S657, and in step S658 that the block order to buy at 2½ can match against responses to sell at 2½ as well as orders and quotations in the book memory 33.

TABLE XIV

| Number of Contracts to sell | |
|---|---|
| at 2½ | Source |
| 10 CUST | Order in book memory |
| 270 PMM | Quotation in book memory (20) |
| | Response to message (250) |
| 220 PRO #1 | Order in book memory (10) |
| | Response to message (210) |
| 20 PRO #1 | Order in book memory |

Table XIV shows that there is a total of 520 contracts available to match against the block order to buy. In step S662, it is determined that the order is to buy. In step S664, the price of the transaction is determined. In this example, the block order was to buy 500 at 2½. Since there are more than 500 contracts to match at 2½ and no responses or orders and quotations in the book memory 33 at a price lower than the block order price, the execution price is determined to be 2½, and there is nothing to execute at step S665. The public customer order for 10 contracts is executed at step S666, and the block order and facilitation process 35 applies the allocation algorithm in step S667 according to the same process illustrated in FIG. 4(b).

TABLE XV

| Price | Number of contract of buy | Source |
|---|---|---|
| 4 | 10 | Order in book memory |
| 3⅞ | 70 | Quotation in book memory (20) |
| | | Response to message (50) |
| 3¾ | 20 | Cust Order in book memory (10) |
| | | Response to message (10) |

As an example of how the execution price is determined, assume that a block order to sell 75 at 3¾ is entered. After completing steps S650 through S657, Table XV represents the responses and order and quotations to buy. The block order and facilitation process 35 determines that the block order can match in step S658 and moves through step S662. The execution price is determined in step S668 as the highest price at which the entire order can be matched, which in this example is 3⅞. The order in the book memory to buy at 4 will be executed at 3⅞ first at step S669. There are no public customer orders at 3⅞, so the process moves through step S670 to apply in step S671 the allocation algorithm described above and illustrated in FIG. 5(b).

As illustrated in FIG. 11(c), the process for execution of facilitation orders trades a defined certain percentage of the original size of the facilitation against to the EAM 9,11 in steps S6S5 and S693 that entered the facilitation order prior to applying the allocation algorithms illustrated in FIGS. 4(b) and 5(b) in steps S687 and S696 respectively. Further, after completing steps S687 and S696, any remaining unexecuted portion of the facilitation order is traded against the EAM 9,11 that entered the facilitation order. The percentage of the facilitation order automatically executed against the EAM 9,11 that entered the facilitation is a value that is stored in the system memory 26.

### Quotation Matching Process

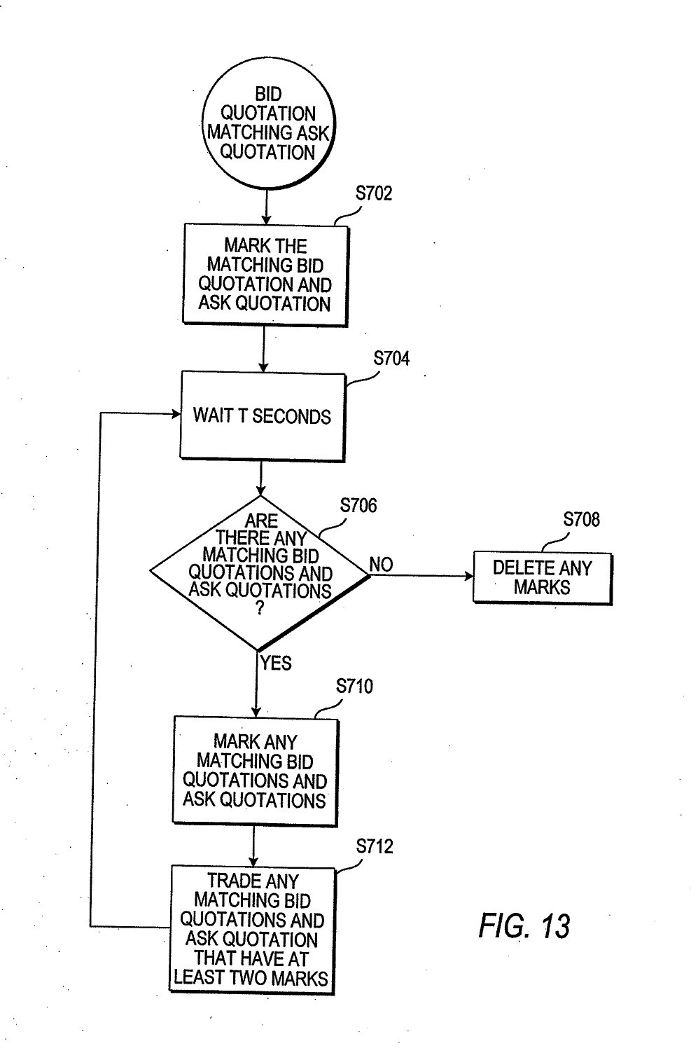

FIG. 13 illustrates the quotation matching process 31, which introduces a delay before automatically matching a bid and an ask quotation. The idea is to prevent quotations from matching only because one participant's automatic quotation system updates its quotation slightly more quickly than another participant's automatic quotation system. As an example, if there is a quotation in the book memory 33 to buy at 4 and a CMM 5,7 enters a quotation to sell at 4, the quotation matching process marks the quotation to buy and the quotation to sell in step S702 and then waits T seconds in step S704, T beingg a variable stored in the system memory 26. In step S706, the process determines whether there exists a bid and an offer that match, since during T quotations may have changes. If there are no matching bids and offers, the marks from step S702 are removed in step S708. If there are bids and offers that match, the process marks those quotations in step S710 and executes the matching quotations that have two or more marks at step S712. The process then returns to step S704 to again wait T seconds.

### Complex Order Process

A complex, combination, or spread order (complex order) contains a set of legs, each leg representing a different financial instrument on the same underlying product. Embodiments of the described and illustrated herein are in terms of each of the legs consisting of series of equity options contracts. However, the invention is not limited to trading equity options complex orders. Rather, the invention can be implemented in any asset class or among several asset classes (such as, for example, legs consisting of index options contracts, futures contracts, stock, bonds, treasury instruments, exchange traded funds, security futures, etc. or any combination thereof), and a discussion of how the invention can be implemented in different or across asset classes is described in detail below.

In order for a complex order to trade, all legs must be simultaneously executed either in whole or in the part pursuant to the ratio set forth in the complex order, and the complex order must trade at a single, net price. A complex order may be designated as a market order or limit order, and may contain various conditions or qualifiers, such as, for example, all or none (AON), fill and store (FAS), immediate or cancel (IOC), etc., and have a time in force of day, good till canceled (GTC), delete after n minutes, or some other time in force. A complex order can be entered, changed, canceled, and traded.

According to one embodiment of the invention, a centralized orderbook memory to store complex orders and regular orders. This orderbook may comprise the book memory 33, shown in FIG. 2. The complex order process 50 continually monitors the best price and size of all quotes and orders in the orderbook (including both complex orders and regular orders) (referred to as the best bid and offer or BBO), as well as market information from other linked markets (referred to as the OPRA BBO), to determine whether complex orders can match against other complex orders and regular orders. The complex order process 50 assigns priority levels to complex orders and regular orders, and determines the best possible price to trade complex orders, whether it is against other complex orders or regular orders. The complex order process 50 ranks complex orders in time and price priority and matches complex orders according to this ranking to prevent complex orders to trade through or ahead of orders ranked higher in priority or orders at better prices. After receiving a complex order, the complex order process 50 displays the complex order to market participants for a programmable period to allow those participants to submit matching orders. Matching orders are ranked during this period in terms of price, allowing for price improvement in trading the complex order.

Once a match is found the complex order process 50 sends the complex order and matching orders to the execute trade process 27, which simultaneously executes the legs of a complex order against regular orders in the orderbook or against a matching complex order, thereby removing market or leg risk. Where the complex order process 50 matches part of the complex order against regular orders and quotations, the match is made so that the quantity of each leg of the complex order matched satisfies the ratios of the legs specified in the complex order. For example, if the complex order is an order to buy 100 of Leg 1 and Sell 50 of Leg 2 (having a ratio of 2 to 1) with a net price of $15 and regular orders to sell 100 at $10 for Leg 1 and to buy 30 at $5 for Leg 2 are showing, the complex order process 50 would cause a trade to buy 60 and sell 30 (keeping the 2 to 1 ratio).

After a complex order has traded, a message is sent to the parties to the trade and trade information is reported to market participants and others. All market participants, including PMMs, CMMs and EAMs, can enter complex orders.

An example of a complex order having two legs, both of which consist of series of equity option contracts, is:

### Quantity=10

### Net Price 0.30

Buy 1 Series 1, ratio 1
Sell 1 Series 2, ratio 1
In this example, the complex order process 50 calculates the best bid or offer (BBO) for each leg of the above complex order is:

| | |
|---|---|
| BBO_{bid} | BBOₐₛₖ |

| | | | |
|---|---|---|---|
| Leg 1 | 0.50 | × | 0.60 |
| Leg 2 | 0.30 | × | 0.40 |

Thus, in this example, the processor calculates the valid spread range for this order to be 0.10-0.30. The spread range is calculated as follows: (i) multiply the BBO prices by the ratio to get the ratio-adjusted prices; (ii) using the ratio-adjusted prices total the at-market ask prices for the buy legs and the total at-market bid prices for the sell legs (iii) Subtract the sell total from the buy total (this yields 0.30); (iv) repeat step ii using the opposite side of the BBO and total bid prices for buy legs and total offer prices for sell legs; (v) subtract sell total from buy total (this yields 0.10). The complex order process 50 uses this spread range to maximize the matching possibilities (and thus liquidity available) for the complex order. For a complex order, the price of each leg can vary, but the net price cannot be greater than 0.30 per contract. The bottom of the range is also referred to as the synthetic low. The top of the range is referred to as the synthetic high.

The user entering the complex order can change some of the values of the complex order or delete it. Examples of some changes include, but are not limited to: decreasing the volume; selecting open or close; changing the validity time from, e.g., GTC to rest of day; changing the broker identity; changing the client identity; changing the free text; changing the clearing member; changing the order type from interest to limit, etc.

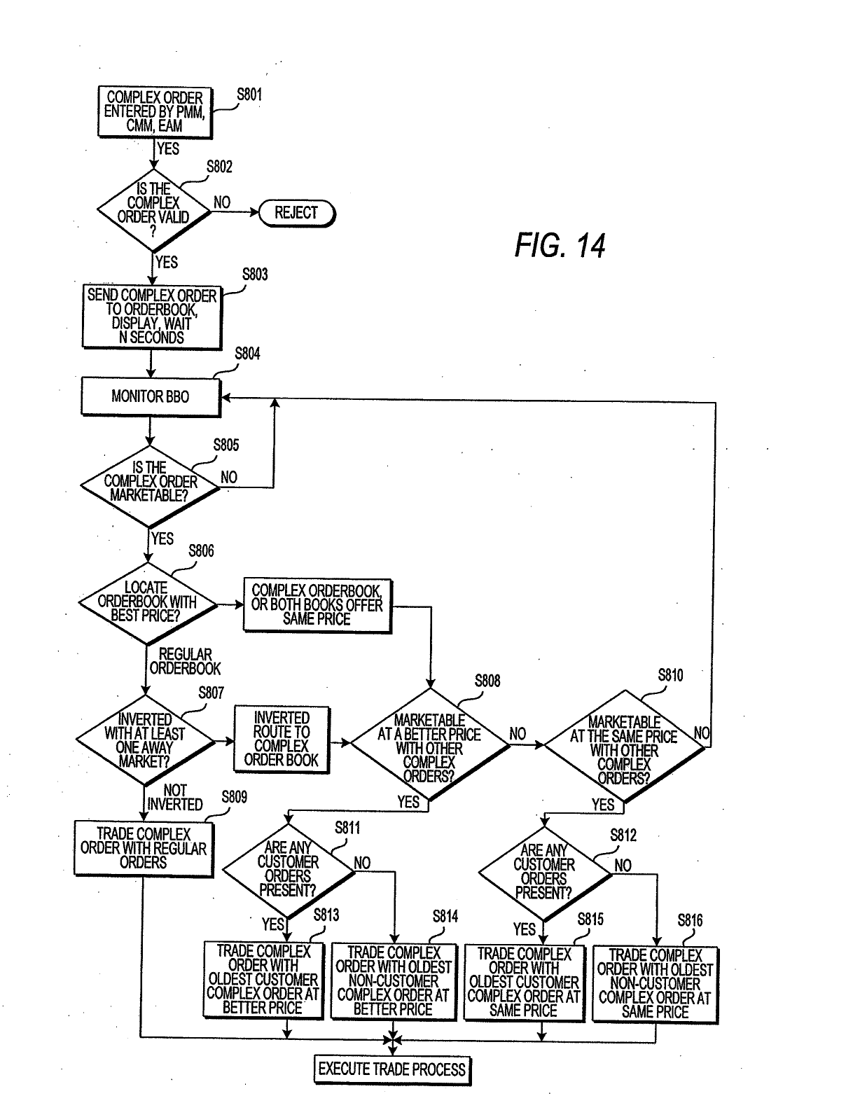

FIG. 14 shows the operation of the complex order process 50 according to an embodiment of the invention. At Step S801, a complex order is entered into the system by a PMM, CMM, or EAM. At Step S802, the system validates the complex order. A valid complex order has a net price (which may be specified as fixed price or market price) and at least one leg. Each leg includes: (1) the series; (2) the ratio; (3) buy or sell value; and (4) the quantity. If the complex order is not valid, the complex order is rejected. If the complex order is valid, the complex order is sent to the orderbook and displayed to market participants. At Step S803, the system introduces an optional delay of n seconds before the processor starts seeking matches for the complex order. The purpose of the delay is to provide market participants with an opportunity to trade against the order and/or improve the execution price of the order through submitting inverse (or opposite) orders. This parameter can be changed dynamically intraday by the administering exchange and can optionally be set to zero. If the complex order is traded during delay period, the complex order is removed from the book and reported to the relevant market participants.

If the complex order is not traded during the delay period, at Step S804, the complex order process 50 is triggered and it checks the BBO for each leg of the complex order. The complex order process 50 rechecks the BBO each time it is retriggered. The complex order process 50 is retriggered by certain events, such as, for example: (1) a series status change; (2) a BBO update; (3) an OPRA BBO update; and (4) a complex order update. When the complex order process 50 is triggered, it: (a) selects the complex orders relating to the complex order or series that caused the trigger from the orderbook; (b) lists the selected complex orders by receipt time; (c) groups the selected complex orders by identical leg characteristics; and (d) sorts the selected complex orders with identical leg characteristics in price-time priority.

At Step S805, the complex order process 50 uses validations to determine whether the complex order is marketable against other complex orders and regular orders. The validations include determining whether: (1) the series for each leg has a valid price; (2) the series for each leg has a valid trading status; (3) a prior primary complex order with the same attributes partially traded; and (4) a prior primary complex order with the same attributes did not fail. If a prior complex order with the same attributes failed to be matched, the complex order process 50 skips the complex order.

The BBO for each series of the regular orders is used to calculate the value of the complex order. The synthetic low is the lowest price; the synthetic high is the highest price. The synthetic low and high are also referred to as the complex order BBO from the regular orders. The net price of the complex order must be greater than or equal to the synthetic low. If there is a customer order at the low, the net price of the complex order must be greater than the synthetic low. The net price of the complex order must be less than or equal to the synthetic high plus a price buffer. The price buffer is a parameter configurable by the administering exchange. Optionally, the price buffer may be set to zero.

If the complex order is not marketable, the complex order is not traded and the system loops back to the monitoring the BBO at Step S804 and waits for the complex order process 50 to retrigger. If the complex order is marketable, the complex order process 50 determines whether an inverse complex order or regular orders on the orderbook offers a better price to trade the complex order at Step S806. To do so, the complex order process 50 (1) sorts the inverse complex orders by price then time priority, ignoring such orders if (a) they are less than the net price that was requested by the complex order, and (b) their net price is outside of the valid spread range of the complex order; and (2) checks the best complex order price against the current best matching price against regular orders.

Specifically, the complex order process 50 prioritizes, sorts, and ranks the inverse complex orders to determine the best inverse complex order in the following manner:

(a) The complex order process 50 multiplies the net price of the first inverse complex order by −1 to create the calculated net price;

(b) If the calculated net price is less than or equal to the complex order and the synthetic high, this inverse complex order is queued with the complex order. Otherwise, the inverse complex order is skipped.

(c) If the calculated net price is less than the current best matching price, this inverse complex order is queued with the complex order and the calculated net price becomes the new current best matching price.

(d) If the calculated net price is equal to the current best matching price and the synthetic high, and there is no customer at the synthetic high, this inverse complex order is queued in time priority.

(e) If the calculated net price is equal to the current best matching price but not equal to the synthetic high, and this inverse complex order is older than the previously saved match, this new inverse complex order is queued with the complex order.

(f) The complex order process 50 completes steps (a)-(e) for each of the remaining inverse complex orders and saves the best match.

The complex order process 50 does not queue the complex orders if:

(a) The complex order is AON and the quantity is greater than the quantity of the inverse complex order.

(b) The inverse complex order is AON and the quantity is greater than the quantity of the complex order.

(c) The calculated net price of the inverse complex order is less than the synthetic low minus the configurable price buffer.

As a result of the foregoing steps, at Step S806, the complex order process 50 compares the best inverse complex order price to the best regular order price. If regular orders represent the best price, the processor seeks to match the complex order against the regular orders. If an inverse complex order represents the best price, the complex order process 50 seeks to match the complex order against an inverse complex order. If both an inverse complex order and regular orders represent the same price and there would be no priority or other trading violations, the complex order process 50 seeks to match the complex order against an inverse complex order.

Specifically, at Step S807, if the complex order process 50 seeks to match the complex order with regular orders, the complex order process 50 checks whether any of the legs of the complex order are inverted. If none of the legs of the complex order are inverted, the complex order process 50 matches the trade against the regular orders at Step S809 according to the allocation algorithm described in FIGS. 4(a)-5(b). If one or more of the legs of the complex order is inverted, the complex order process 50 seeks to match the complex order against an inverse complex order at Step S808.

If the best price match is an inverse complex order and the complex order is older, the complex order is matched with the inverse complex order at the price of the complex order.

If the net price of the complex order: (1) is greater than the synthetic high, the net price becomes the new synthetic high; (2) is equal to the synthetic high and there is a customer at the high, the processor ticks the net price lower. (If the net price is lower than the limit price of the inverse complex order or below the low end of the range, the complex order process 50 does not match the complex orders.); (3) is less than the synthetic low, the complex order process 50 does not match the complex orders; (4) is equal to the synthetic low and there is a customer at the low, the complex order process 50 does not match the complex orders.

If the best match is an inverse complex order and the complex order is younger, the complex order is matched with the inverse complex order at the price of the inverse complex order.

If the net price of the inverse complex order: (1) is less than the synthetic low, the net price becomes the new synthetic low; (2) is equal to the synthetic low and there is a customer at the low, tick the net price higher (if the net price is higher than the limit price of the complex order or greater than the high end of the range, the complex order process 50 does not match the complex order); (3) is greater than the net price of the complex order or the synthetic high, the complex order process 50 does not match the complex order; and (4) is equal to the synthetic high and there is a customer at the high, the processor does not match the complex order.

After the complex order process 50 matches the complex order with the best inverse order, it executes the trade. The trade may consist of a trade between two complex orders on the orderbook at a specified net price; a complex order against regular orders on the orderbook at the price of the book, up to the limit of the complex order; and a complex order against regular orders on the orderbook, then trade the complex order against other complex orders on the orderbook.

After the complex order process 50 matches the complex order with the best regular orders, it executes the trade according to the allocation algorithm set forth in FIGS. 4(a)-5(b). Each leg of the complex order is executed at the book price, and the complex order process 50 ensures that the current BBO for each leg will not exceed the limit price of the complex order.

After a complex order is executed, the system: (1) recalculates the BBO and sends it to all market participants; (2) reports the details of the trade to OPRA; and (3) sends the trade record to clearing members.

As discussed above, the invention can be implemented in any asset class or across asset classes. By way of example, the invention can be implemented in trading stock and equity options complex orders. The complex order process 50 eliminates leg risk by executing such complex orders as a single transaction. The complex order process 50 records and processes market data from each of the markets on which the instruments are traded. According to one embodiment it receives information from SIAC (for CTS and CQS) and ISE (for ISE market and order information) via the interface 23. The complex order process 50 then processes the stock and options market information to determine matching opportunities and execute the legs of the trades in both markets as a single transaction at a net price. If the complex order process 50 cannot complete each leg of the complex order in a quantity consistent with any ratios specified in the complex order, the complex order process 50 will not execute the trade. The complex order process 50 triggers may include additional events based on the particular type of asset class. According to one embodiment, when trading stock and equity option complex orders the complex order process 50 triggers on an updated BBO on the stock leg, changes to up-tick when short-selling certain securities, and the like. The complex order process 50 continues to trade such complex orders at a single, net price, and would further enhance liquidity available to these orders as a result of the wider price range available to it to execute such orders as a single transaction. According to this embodiment, the complex order process 50 calculates an options price range, a stock price range, and a total price range within which both the stock and options legs could trade.

### Series Freeze Process

One common trading strategy is the combination of one or more option legs and a leg for shares of the underlying stock at a certain ratio of options to shares, where the trade takes place at a net price. The options and the shares may not be available on a single market or may not be available on a single market at the best price. According to an embodiment of the invention, where different legs of a complex order are executed on different markets, the system provides a mechanism for synchronizing execution on those markets.

According to this embodiment, synchronized execution of such combination orders is accomplished by halting or “freezing” transactions for the leg or legs of the order being executed in a local market while it attempts to execute the remaining leg in a remote market. In a preferred embodiment, transactions in the series of options is frozen in the local market while the stock leg of the order is executed in the remote market. Alternatively, trading in the local market for the stock leg may be frozen while the options leg is being executed in the remote market. Prior to freezing transactions on the leg or legs being executed in the local market, the system monitors the remote market and determines whether all or a portion of the remaining leg is marketable on the remote market.

After a period of time has elapsed, or if the leg on the remote market is fully executed, the trading in the local market that was frozen is unfrozen. For example, if the stock leg is executed or partially executed in the remote market, the options leg in the local market is executed. The quantity of options executed depends on the desired ratio of the complex order and on the number of stock shares executed. While the trading of the option series is frozen, all transactions for those option series are queued. Queued transactions are processed in time priority when trading in the series resumes.

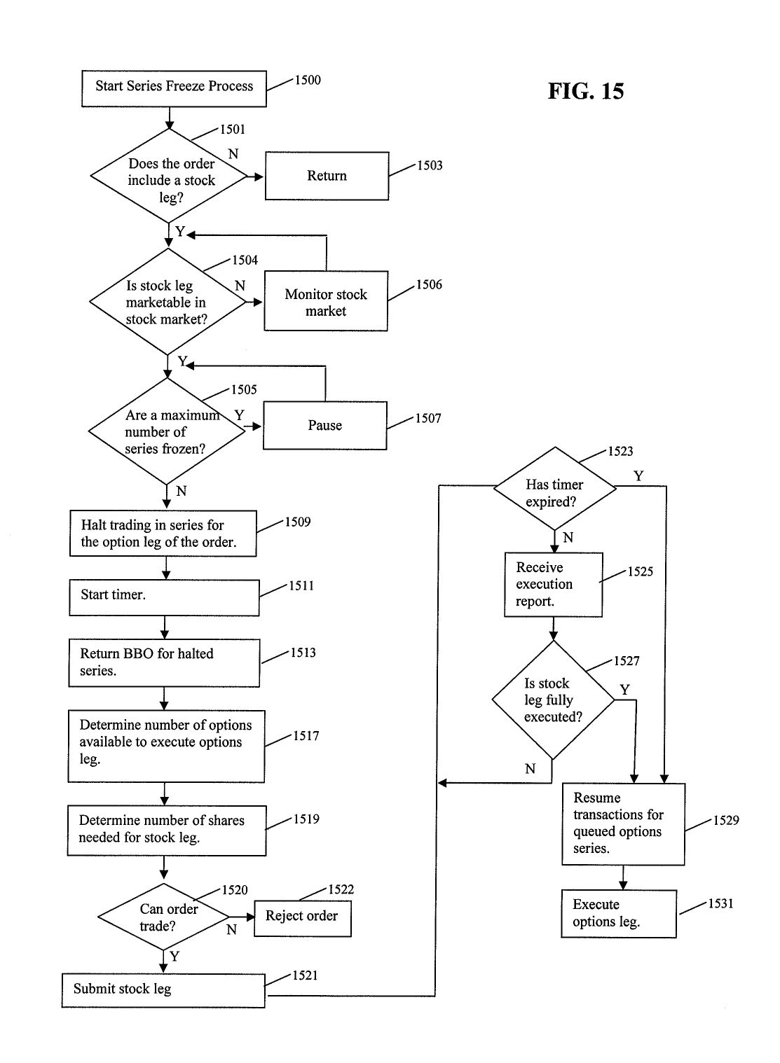

FIG. 15 is a process flow diagram illustrating an embodiment of the invention. When an order is received by the complex order process 50 that includes one or more legs where one or more legs will be executed in a local market and one or more legs will be executed on a remote market, the process shown in FIG. 15 is executed. The preferred embodiments are described in terms of a complex order with an options leg executed in the local market and a leg for the stock underlying that option executed on the remote market. But the invention is not limited to processing complex orders including these securities. As those skilled in the field of the invention will appreciate, the present invention is applicable to complex orders including other types of securities, for example, those including legs for futures contracts, commodities, foreign currency, index options, exchange-traded funds, etc.

At step 1501 the system determines whether the complex order includes a stock leg. If not, then the current order is not a complex order, and the system awaits receipt of a complex order. At step 1504 the system determines if all or a portion of the stock leg is marketable on a remote market. If it is not, at step 1506, the system monitors the remote market and resumes processing the complex order when the stock leg becomes marketable. At step 1505 the system determines whether freezing the options series for this complex order will exceed a predetermined maximum number of frozen series for the orderbook. If so, at step 1507 this attempt to freeze the series is rejected and the system will try again after a short delay. This is to ensure that freezing the series does not cause latency in the overall exchange functionality because too many series are frozen at one time. A series freeze request will also be denied if the series is already frozen or if series freezing has been disabled. The rejection reason will be logged.

At step 1509 the option series for the options leg or legs of the complex order is placed in a halted or Frozen state and all further transactions for this series will be queued. At step 1511a timer is started. The timer will expire after a predetermined interval, after which the Frozen series will be unfrozen should the remote exchange fail to respond within a predetermined timeframe. While the series is in the Frozen state all transactions for the Frozen series are placed in a queue. These queued transactions could include, but are not limited to, order entry, order delete, or order amendment transactions. The BBO of the frozen series is recalculated at step 1513. At step 1517 the system will recalculate the number of options available on each options leg and at step 1519, the system will calculate the number of shares needed to satisfy this order, given the number of options that are available on each leg. According to one embodiment, the system also determines a limit price to purchase the stock shares based on a net price target for the complex order and the price to execute the options leg by computing a synthetic high and synthetic low, described above.

At step 1520 the system determines if the complex order cannot trade, because, for example, there is insufficient liquidity on the options or stock markets to fill an order with an AON or FOK instruction or because the net price cannot be achieved. If so, at step 1522 the complex order is rejected.

At step 1521, the system submits the stock leg to a stock exchange. According to one embodiment, the stock leg is sent to NYFIX for execution, but it can be sent to any stock exchange interface. At step 1523, the system determines if the timer has expired. If the timer has not expired, at step 1525 an execution report is received from the stock exchange. At step 1527 the system determines if there are additional stock transactions required to fill the stock leg. If the stock execution request is for a market order, the fill could be at the multiple price levels and the stock market will send multiple execution reports for each price level. Once either the stock leg is filled or the timer expires, the options series is unfrozen and the options leg as well as any queued transactions are executed in steps 1529 and 1531. If the order is not fully filled before the timer expires, the option leg will be traded on partial stock executions and/or continue with the regular matching process. If an IOC or FOK cancel report is received for the stock leg, a series unfreeze request will be sent to the options leg.

The above embodiments are illustrative of the present invention. It is to be understood that the invention is not intended to be limited by this disclosure, but rather is intended to cover various modifications and equivalent arrangements included within the spirit and scope of the invention, as will be apparent to a person of ordinary skill in the art.

We claim:

1. A method for executing a financial transaction to trade a complex order comprising the steps of:
receiving a complex order, the complex order including a first order to purchase or sell a first quantity of a first financial instrument and a second order to purchase or sell a second quantity of a second financial instrument;
identifying a first market on which to purchase or sell the first instrument;
identifying a second market on which to purchase or sell the second instrument, wherein the second market includes a plurality of previously received orders;
halting trading on the first market;
executing the purchase or sale of the second instrument on the second market while trading on the first market is halted, wherein the second instrument is executed against one or more of the plurality of previously received orders according to a priority scheme;
determining that the whole of the second quantity of the second instrument was purchased or sold; and
executing the purchase or sale for the first quantity of the first instrument on the first market, wherein the first quantity and the second quantity represent a predetermined ratio.

2. The method of claim 1, further comprising the steps of:
determining that less than the whole of the second quantity was purchased or sold; and
executing the purchase or sale of a portion of the first quantity of the first instrument on the first market, wherein the portion of the first quantity and the portion of the second quantity represent the predetermined ratio.

3. The method of claim 1, further comprising the step of determining a cost to purchase or sell the first and second quantities of the first and second instruments based on prices for the instruments on the first and second markets while trading is halted on the first market.

4. The method of claim 1, further comprising the steps of:
determining a time that trading on the first market has been halted;
determining that the time has exceeded a predetermined maximum market halt period; and
cancelling the first and second orders if the step of executing has not occurred.

5. The method of claim 1, wherein the first order is for the purchase or sale of a derivative security and the second order is for the purchase or sale of the underlying instrument of the derivative security.

6. The method of claim 1, wherein the first order is for the purchase or sale of stock options contracts and the second order is for the purchase or sale of the stock underlying the options contracts.

7. The method of claim 1, wherein executing the first order of the complex order is contingent on executing the second order of the complex order.

8. The method of claim 3, wherein the complex order further comprises a net price and wherein execution of the complex order is halted if the cost exceeds the net price.

9. The method of claim 1, wherein one of the first and second financial instruments includes at least one options contract.

10. The method of claim 9, wherein one of the first and second financial instruments includes at least one order to purchase or sell stock underlying the at least one options contract.

11. The method of claim 1, wherein one of the first and second financial instruments includes at least one futures contract.

12. The method of claim 11, wherein one of the first and second financial instruments includes an amount of a commodity underlying the at least one futures contract.

13. The method of claim 1, further comprising an arrival delay timer, the arrival delay timer delaying execution of the complex order for a period of time from receiving the complex order.

14. The method of claim 1, wherein the previously received orders include orders associated with non-professionals and professionals, and wherein orders from non-professionals are ranked with a higher priority for execution than orders received from professionals according to the priority scheme.

15. The method of claim 1, wherein a previously received order stored earliest in time is ranked with a higher priority for execution than a previously received order stored later in time according to the priority scheme.

16. The method of claim 3, further comprising the steps of:
determining that the cost is greater than the net price;
halting execution of the complex order;
monitoring prices on the first and second markets; and
resuming execution of the complex order when the cost is less than or equal to the net price.
